(19) United States
(12) Patent Application Publication
(10) Pub. No.: US 2011/0109286 A1
(43) Pub. Date: May 12, 2011

(54) Power switching circuit

(76) Inventors: Yen-Wei Hsu, Taipei (TW); Whei-Chyou Wu, Fremont, CA (US)

(21) Appl. No.: 12/616,147

(22) Filed: Nov. 11, 2009

(51) Int. Cl. G05F 1/10

(52) U.S. Cl. 323/282

(57) ABSTRACT

This invention relates to a power switching circuit, and, the switching circuit has very wide bandwidth, better capability to deal with bigger power and better capability to increase chances to impedance-match with loading. The invention has also revealed a backward current decoupler which can be used to drive a loading so that a better capability to impedance-match with loading can be achieved.

### FIELD OF INVENTION

This invention relates to a power switching circuit, and, the switching circuit has very wide bandwidth, better capability to deal with bigger power and better capability to increase chances to impedance-match with loading. The invention has also revealed a backward current decoupler which can be used to drive a loading so that a better capability to impedance-match with loading can be achieved. The invention has revealed a new sensor, capacitor and an inductor based on the backward current decoupler.

### BACKGROUND INFORMATION

### Introduction

Referring to [4], [33], [41, Vol. 1 Chapter 50] and [23, Page 402], the nonlinear system response produces many un-modeled effects: jump or singularity, bifurcation, rectification, harmonic and subharmonic generations, frequency-amplitude relationship, phase-amplitude relationship, frequency entrainment, nonlinear oscillation, stability, modulations (amplitude, frequency, phase) and chaoes. In the nonlinear analysis fields, it needs to develop the mathematical tools for obtaining the resolution of nonlinearity. Up to now, there exists three fundamental problems which are self-adjoint operator, spectral (harmonic) analysis, and scattering problems, referred to [31, Chapter 4.], [37, Page 303], [34, Chapter X], [36, Chapter XI], [35, Chapter XIII], [24] and [33, Chapter 7.].

There are many articles involved the topics of the nonlinear spectral analysis and reviewed as the following sections. The first one is the nonlinear dynamics and self-excited or self-oscillation systems. It provides a profound viewpoint of the non-linear dynamical system behaviors, which are duality of second-order systems, self-excitation, orbital equivalence or structural stability, bifurcation, perturbation, harmonic balance, transient behaviors, frequency-amplitude and phase-amplitude relationships, jump phenomenon or singularity occurrence, frequency entrainment or synchronization, and so on. In particular, the self-induced current (voltage) or electricity generation appears if applying to the Liénard system.

### Dielectric Materials

Referring to [30, Chapter 4, 5, 8, 9], [19, Part One], [20, Chapter 1], [7, Chapter 14], the response of a material to an electric field can be used to advantage even when no charge is transferred. These effects are described by the dielectric properties of the material. Dielectric materials pons a large energy gap between the valence and conduction bands, thus the materials a high electrical resistivity. Because dielectric materials are used in the AC circuits, the dipoles must be able to switch directions, often in the high frequencies, where the dipoles are atoms or groups of atoms that have an unbalanced charge. Alignment of dipoles causes polarization which determines the behavior of the dielectric material. Electronic and ionic polarization occur easily even at the high frequencies. Some energy is lost as heat when a dielectric material polarized in the AC electric field. The fraction of the energy lost during each reversal is the dielectric loss. The energy losses are due to current leakage and dipoles friction (or change the direction). Losses due to the current leakage are low if the electrical resistivity is high, typically which behaves 10¹¹ Ohm·m or more. Dipole friction occurs when reorientation of the dipoles is difficult, as in complex organic molecules. The greatest loss occurs at frequencies where the dipoles almost, but not quite, can be reoriented. At lower frequencies, losses are low because the dipoles have time to move. At higher frequencies, losses are low because the dipoles do not move at all.

For a capacitor made from dielectric ceramics, referred to [19, Part One], [20, Chapter 1], [30, Page 253-255], its capacitance C, which is equivalent to one ideal capacitor Cᵢ and series resistance Rₛ in the FIG. 5, is function of frequency ω, equivalent series resistance Rₛ and loss tangent of dielectric materials tan(δ) as

$$C = \frac{tan ( δ )}{{R}_{s} ω} \qquad ( 1 )$$

respectively. That is, if changing the Rₛ, tan(δ) for different materials or ω, the C becomes a variable capacitance.

### Cauchy-Riemann Theorem

Referring to the [42], [11], [40] and [3], the complex variable analysis is a fundamental mathematical tool for the electrical circuit theory. In general, the impedance function consists of the real and imaginary parts. For each part of impedance functions, they are satisfied the Cauchy-Riemann Theorem. Let a complex function be

z(x,y)=F(x,y)+iG(x,y) (2)

where F(x, y) and G(x, y) are analytic functions in a domain D and the Cauchy-Riemann theorem is the first-order derivative of functions F(x, y) and G(x, y) with respect to x and y becomes

$$\begin{matrix}\frac{\partial F}{\partial x} = \frac{\partial G}{\partial y} \\ and & ( 3 ) \\ \frac{\partial F}{\partial y} = - \frac{\partial G}{\partial x} & ( 4 )\end{matrix}$$

Furthermore, taking the second-order derivative with respect to x and y, we can obtain two 2^{nd}-order partial differential equation as

$$\begin{matrix}\frac{{\partial }^{2} F}{\partial {x}^{2}} + \frac{{\partial }^{2} F}{\partial {y}^{2}} = 0 \\ and & ( 5 ) \\ \frac{{\partial }^{2} G}{\partial {x}^{2}} + \frac{{\partial }^{2} G}{\partial {y}^{2}} = 0 & ( 6 )\end{matrix}$$

respectively, also F(x, y) and G(x, y) are called the harmonic functions.

From the equation (2), the total derivative of the complex function z(x, y) is

$$dz ( x , y ) = ( \frac{\partial F}{\partial x} dx + \frac{\partial F}{\partial y} dy ) + i ( \frac{\partial G}{\partial x} dx + \frac{\partial G}{\partial y} dy ) \qquad ( 7 )$$

and substituting equations (3) and (4) into the form of (7), then the total derivative of the complex function (2) is dependent on the real function F(x, y) or in terms of the real-valued function F(x, y) (real part) only,

$$dz ( x , y ) = ( \frac{\partial F}{\partial x} dx + \frac{\partial F}{\partial y} dy ) + i ( \frac{\partial F}{\partial x} dy - \frac{\partial F}{\partial y} dx ) \qquad ( 8 )$$

and in terms of a real-valued function G(x, y) (imaginary part) only,

$$dz ( x , y ) = ( \frac{\partial G}{\partial y} dx - \frac{\partial G}{\partial x} dy ) + i ( \frac{\partial G}{\partial x} dx + \frac{\partial G}{\partial y} dy ) \qquad ( 9 )$$

There are the more crucial facts behind the (8) and (9) potentially. As a result, the total derivative of the complex function (7) depends on the real (imaginary) part of (2) function F(x, y) or G(x, y) only and never be a constant value function. One said, if changing the function of real part, the imaginary part function is also varied and determined by the real part via the equations (3) and (4). Since the functions F(x, y) and G(x, y) have to satisfy the equations (5) and (6), they are harmonic functions and then produce the frequency related elements discussed at the analytic continuation section. Moreover, the functions of real and imaginary parts are not entirely independent, referred to the Hilbert transforms in the textbooks [17, Page 296] and [19, Page 5 and Appendix One].

### Positive and Negative Differential Resistances (PDR, NDR)

More inventively, due to observing the positive and negative differential resistors properties qualitatively, we introduce the Cauchy-Riemann equations, [26, Part 1, 2], [42], [11], [40] and [3], for describing a system impedance transient behaviors and particularly in some sophisticated characteristics system parametrization by one dedicated parameter ω. Consider the impedance z in specific variables (i, v) complex form of

z=F(i,v)+jG(i,v) (10)

where i, v are current and voltage respectively. Assumed that the functions F(i, v) and G(i, v) are analytic in the specific domain. From the Cauchy-Riemann equations (3) and (4) becomes as following

$$\begin{matrix}\frac{\partial F}{\partial i} = \frac{\partial G}{\partial v} \\ and & ( 11 ) \\ \frac{\partial F}{\partial v} = - \frac{\partial G}{\partial i} & ( 12 )\end{matrix}$$

where in these two functions there exists one relationship based on the Hilbert transforms [17, Page 296] and [19, Page 5]. In other words, the functions F(i, v) and G(i, v) do not be obtained individually. Using the chain rule, equations (11) and (12) are further obtained

$$\begin{matrix}\frac{\partial F}{\partial ω} \frac{d ω}{d i} = \frac{\partial G}{\partial ω} \frac{d ω}{d v} \\ and & ( 13 ) \\ \frac{\partial F}{\partial ω} \frac{d ω}{d v} = - \frac{\partial G}{\partial ω} \frac{d ω}{d i} & ( 14 )\end{matrix}$$

where the parameter ω could be the temperature field T, magnetic field flux intensity B, optical field intensity I, in the electric field for examples, voltage v, current i, frequency ω or electrical power P, in the mechanical field for instance, magnitude of force F, and so on. Let the terms

$$\begin{matrix}\{ \begin{matrix}\frac{d ω}{d v} > 0 \\ \frac{d ω}{d i} > 0\end{matrix} \\ or & ( 15 ) \\ \{ \begin{matrix}\frac{d ω}{d v} < 0 \\ \frac{d ω}{d i} < 0\end{matrix} & ( 16 )\end{matrix}$$

be non-zero and the same sign. Under the same sign conditions as equation (15) or (16), from equation (13) to equation (14),

$$\begin{matrix}\frac{\partial F}{\partial ω} > 0 & ( 17 ) \\ \frac{\partial F}{\partial ω} < 0 \\ and & ( 18 ) \\ \frac{\partial F}{\partial ω} = 0 & ( 19 )\end{matrix}$$

should be held simultaneously, where (19) means a constant resistor. From the viewpoint of making a power source, the simple way to perform equations (15) and (16) is to use the pulse-width modulation (PWM) method.

The further meaning of (15) and (16) is that using the variable frequency ω in pulse-width modulation to current and voltage is the most straightforward way, i.e.,

$$\{ \begin{matrix}\frac{\partial ω}{\partial v} \neq 0 \\ \frac{\partial ω}{\partial i} \neq 0\end{matrix} \qquad ( 20 )$$

In nature,

$$\frac{\partial F}{\partial ω} and \frac{\partial G}{\partial ω}$$

are positive or in general, under the condition like as the (21)

$$\frac{\partial F}{\partial ω} \frac{\partial G}{\partial ω} > 0 \qquad ( 21 )$$

in equation (15) or (16), we can obtain the result of

$$\frac{\partial ω}{\partial v} \frac{\partial ω}{\partial i} < 0 \qquad ( 22 )$$

In the report [39], we can find a negative slope in the I-V curve of some special fiber-carbon materials

$$\frac{d V}{d I} = - R$$

or in pararmeter form

$$\frac{\frac{d V}{d ω}}{\frac{d I}{d ω}} = - R$$

where the resistance R is a positive value,

$$R > 0$$

$$or$$

$$\frac{d V}{d ω} \frac{d I}{d ω} < 0$$

also its equivalent form

$$\frac{d ω}{d V} \frac{d ω}{d I} < 0$$

The negative sign contributed from the current or voltage has a backward direction with respect to input current I or voltage V. In particular, this reverse current (−I) is to be called “backflow.” After obtaining the qualitative behavoirs of equation (17) and equation (18), also we need to further respectively define the quantative behavoirs of equation (17) and equation (18). Intuitively, any complete system described by the equation (10) could be analogy to the simple-parallel oscillator as FIG. 1 or simple-series oscillator as FIG. 2 which corresponds to 2^{nd}-order differential equation respectively either as (25) or (30). Referring to [41, Vol 2, Chapter 8, 9, 10, 11, 22, 23], [16, Page 173], [5, Page 181], [21, Chapter 10] and [13, Page 951-968], as the FIG. 1, let the current iₗ and voltage v_{C} be replaced by x, y respectively. From the Kirchhoff's Law, this simple oscillator is expressed as the form of

$$\begin{matrix}L \frac{d x}{d t} = y & ( 23 ) \\ C \frac{d y}{d t} = - x + {F}_{p} ( y ) & ( 24 )\end{matrix}$$

or in matrix form

$$[ \begin{matrix}\frac{d x}{d t} \\ \frac{d y}{d t}\end{matrix} ] = [ \begin{matrix}0 & \frac{1}{L} \\ - \frac{1}{C} & 0\end{matrix} ] [ \begin{matrix}x \\ y\end{matrix} ] + [ \begin{matrix}0 \\ \frac{{F}_{p} ( y )}{C}\end{matrix} ] \qquad ( 25 )$$

where the function Fₚ(y) represents the generalized Ohm's law and for the single variable case, Fₚ(x) is the real part functin of the impedance function equation (10), the “p” in short, is a “parallel” oscillator. Furthermore, equation (25) is a Liénard system. The quality factor Qₚ is defined as

$$\begin{matrix}{Q}_{p} ≡ \frac{1}{2 {ξ}_{p}} \\ = \frac{{ω}_{pm} {f}_{p} ( y )}{L}\end{matrix} \qquad ( 26 )$$

where ξₚ is the damping ration of (25),

$${ω}_{pm} = \frac{1}{\sqrt{LC}} \qquad ( 27 )$$

is the natural frequency of (25) and

$${{f}_{p} ( y ) ≡ \frac{d {F}_{p} ( y )}{d y} \vert}_{y}$$

respectively. If taking the linear from of Fₚ(y),

Fₚ(y)=Ky

and K>0, it is a normally linear Ohm's law. Also, the states equation of a simple series oscillator in the FIG. 2 is

$$\begin{matrix}L \frac{d x}{d t} = y - {F}_{s} ( x ) & ( 28 ) \\ C \frac{d y}{d t} = - x & ( 29 )\end{matrix}$$

in the matrix form,

$$[ \begin{matrix}\frac{d x}{d t} \\ \frac{d y}{d t}\end{matrix} ] = [ \begin{matrix}0 & \frac{1}{L} \\ - \frac{1}{C} & 0\end{matrix} ] [ \begin{matrix}x \\ y\end{matrix} ] + [ \begin{matrix}- \frac{{F}_{s} ( x )}{L} \\ 0\end{matrix} ] \qquad ( 30 )$$

The i_{C}, vₗ have to be replaced by x, y respectively. The function Fₛ(x) indicates the generalized Ohm's law and (30) is the Liénard system too. The corresponding Qₛ value is

$$\begin{matrix}{Q}_{s} = \frac{{ω}_{sn} L}{{f}_{s} ( x )} \\ where & ( 31 ) \\ {ω}_{sn} = \frac{1}{\sqrt{LC}} & ( 32 )\end{matrix}$$

is the natural frequency of (30) and

$${{f}_{s} ( x ) ≡ \frac{d {F}_{s} ( x )}{d x} \vert}_{x}$$

respectively. Again, considering one system as the FIG. 2, let L,C be to one, then the system (30) becomes the form of

$$[ \begin{matrix}\frac{d x}{d t} \\ \frac{d y}{d t}\end{matrix} ] = [ \begin{matrix}y - {F}_{s} ( x ) \\ - x\end{matrix} ] \qquad ( 33 )$$

To obtain the equilibrium point of the system (30), setting the right hand side of the system (33) is zero

$$\{ \begin{matrix}y - {F}_{s} ( 0 ) = 0 \\ - x = 0\end{matrix}$$

where Fₛ(0) is a value of the generalized Ohm's law at zero.
The gradient of (33) is

$$[ \begin{matrix}- {F}_{s}^{′} ( 0 ) & 1 \\ - 1 & 0\end{matrix} ]$$

Let the slope of the generalized Ohm's law Fₛ′ (0) be a new function as ƒₛ(0)

ƒₛ(0)=Fₛ′(0)

the correspondent eigenvalues λ_{1,2}^{s} are as

$${λ}_{1 , 2}^{s} = \frac{1}{2} [ - {f}_{s} ( 0 ) \pm \sqrt{{( {f}_{s} ( 0 ) )}^{2} - 4} ]$$

Similarly, in the simple parallel oscillator (25),

ƒₚ(0)=Fₚ′(0)

the equilibrium point of (25) is set to (Fₚ(0), 0) and the gradient of (25) is

$$[ \begin{matrix}0 & 1 \\ - 1 & {f}_{p} ( 0 )\end{matrix} ]$$

the correspondent eigenvalues λ_{1,2}^{p} are

$${λ}_{1 , 2}^{p} = \frac{1}{2} ( {f}_{p} \pm \sqrt{{( {f}_{p} ( 0 ) )}^{2} - 4} )$$

The qualitative properties of the systems (25) and (30), referred to [13] and [21], are as the following:
1. ƒₛ(0)>0, or ƒₚ(0)<0, its correspondent equilibrium point is a sink.
2. ƒₛ (0)<0, or ƒₚ(0)>0, its correspondent equilibrium point is a source.
   Thus, observing previous sink and source quite different defintions, if the slope value of impedance function Fₛ(x) or Fₚ(y), ƒₛ(x) or ƒₚ(y) is a positive value

Fₛ′(x)=ƒₛ(x)>0 (34)

or

Fₚ′(y)=ƒₚ(y)>0 (35)
it is the name of the positive differential resistivity or PDR.
On contrary, it is a negative differential resistivity or NDR.

Fₛ′(x)=ƒₛ(x)<0 (36)

or

Fₚ′(y)=ƒₚ(y)<0 (37)
3. if ƒₛ(0)=0, or ƒₚ(0)=0, its correspondent equilibrium point is a bifurcation point, referred to [22, Page 433], [23, Page 26] and [21, Chapter 10] or fixed point, [2, Chapter 1, 3, 5, 6], or singularity point, [6], [1, Chapter 22, 23, 24].

Fₛ′(x)=ƒₛ(x)=0 (38)

or

Fₚ(y)=ƒₚ(y)=0 (39)

Liénard Stabilized Systems
This section has used periodical motion to check a system's stability, and also has explained the role of PDR and NDR in a stable system.

Taking the system equation (25) or equation (30) is treated as a nonlinear dynamical system analysis, we can extend these systems to be a classical result on the uniqueness of the limit cycle, referred to [1, Chapter 22, 23, 24], [23, Page 402-407], [32, Page 253-260], [21, Chapter 10, 11] and many articles [25], [18], [29], [27], [28], [15], [10], [38], [9], [14], [8], [12] for a dynamical system as the form of

$$\{ \begin{matrix}\frac{d x}{d t} = y - F ( x ) \\ \frac{d y}{d t} = - g ( x )\end{matrix} \qquad ( 40 )$$

under certain conditions on the functions F and g or its equivalent form of the nonlinear dynamics

$$\frac{{d}^{2} x}{d {t}^{2}} + f ( x ) \frac{d x}{d t} + g ( x ) = 0 \qquad ( 41 )$$

where the damping function ƒ(x) is the first derivative of impedance function F(x) with respect to the state x

ƒ(x)=F′(x) (42)

Based on the spectral decomposition theorem [22, Chapter 7], the damping function has to be a non-zero value if it is a stable system. The impedance function is a somehow specific pattern like as the FIG. 3,

y=F(x) (43)

From equation (40), equation (41) and equation (42), the impedance function F(x) is the integral of damping function ƒ(x) over one specific operated domanin x>0 as

F(x)=∫₀^{x}ƒ(s)ds (44)

Under the assumptions that F, g∈C¹(R), F and g are odd functions of x, F(0)=0, F′(0)<0, F has single positive zero at x=a, and F increases monotonically to infinity for x≧a as x→∞, it follows that the Liénard's system equation (40) has exactly one limit cycle and it is stable. Comparing the (44) to the bifurcation point defined in the section ( ), the initial condition of the (44) is extended to an arbitrary setting as

F(x)=∫ₐ^{x}ƒ(ζ)dζ (45)

where a∈R. Also, the FIG. 4 is modified as where the dashed lines are different initial conditions. Based on above proof and carefully observing the function (42) in the FIG. 4, we conclude the critical insights of the system (40). We conclude that an adaptive-dynamic damping function F(x) with the following properties:
1. The damping function is not a constant. At the interval,

α≦a
the impedance function F(x) is

F(x)<0
The function derivative of F(x) should be

F′(x)=ƒ(x)≧0 (46)
which is a PDR as defined by (34) or (35) and

F′(x)=ƒ(x)<0 (47)
which is a NDR as defined by (36) or (37), and both hold simultaneously. Which means that the impedance function F(x) has the negative and positive slopes at the interval α≦a.
2. Following the Liénard theorem [32, Page 253-260], [21, Chapter 10, 11], [23, Chapter 8] and the correspondent theorems, corollaries and lemma, we can further conclude that one stabilized system which has at least one limit cycle, all solutions of the system (40) converge to this limit cycle even asymptotically stable periodic closed orbit. In fact, this kind of system construction can be realized a stabilized system in Poincaré sense [32, Page 253-260], [21, Chapter 10, 11], [16, Chapter 1, 2, 3, 4], [5, Chapter 3].

Furthermore, one nonlinear dynamic system is as the following form of

$$\begin{matrix}\frac{{d}^{2} x}{d {t}^{2}} + ɛ f ( x , y ) \frac{d x}{d t} + g ( x ) = 0 \\ or & ( 48 ) \\ \{ \begin{matrix}\frac{d x}{d t} = y - ɛ F ( x , y ) \\ \frac{d y}{d t} = - g ( x )\end{matrix} & ( 49 )\end{matrix}$$

where

ƒ(x,y) (50)

is a nonzero and nonlinear damping function,

g(x) (51)

is a nonlinear spring function, and

F(x,y) (52)

is a nonlinear impedance function also they are differentiable. If the following conditions are valid
1. there exists a>0 such that ƒ(x, y)>0 when \sqrt{x²+y²}≦a.
2. ƒ(0,0)<0 (hence ƒ(x, y)<0 in a neighborhood of the origin).
3. g(0)=0, g(x)>0 when x>0, and g(x)<0 when x<0.
4. G(x)=∫₀^{x}g(u)du→∞ as x→∞.
   then (48) or (49) has at least one periodic solution.

### 0.1 Frequency-Shift Damping Effect

This section has used frequency shifting to re-define power generation and dissipation. This section also has revealed frequency shifting produced by a PDR and NDR coupled in series. Referring to the books [3, p 313], [34, Page 10-11], [24, Page 13] and [40, page 171-174], we assume that the function is a trigonometric Fouries series generated by a function g(t)∈L(I), where g(t) should be bounded and the unbounded case in the book [40, page 171-174] has proved, and L (I) denotes Lebesgue-integrable on the interval I, then for each real β, we have

$${lim}_{ω \to ∞} {\int }_{I} g ( t ) {e}^{i ( ω t + β )} d t = 0 \qquad ( 53 )$$

where

e^{i(ωt+β)}=cos(ωt+β)+i sin(ωt+β)

the imaginary part of (53)

$${lim}_{ω \to ∞} {\int }_{I} g ( t ) sin ( ω t + β ) d t = 0 \qquad ( 54 )$$

and real part of (53)

$${lim}_{ω \to ∞} {\int }_{I} g ( t ) cos ( ω t + β ) d t = 0 \qquad ( 55 )$$

are approached to zero as taking the limit operation to infinity, ω→∞, where equation (54) or (55) is called “Riemann-Lebesgue lemma” and the parameter ω is a positive real number. If g(t) is a bounded constant and ω>0, it is naturally the (54) can be further derived into

$$\vert {\int }_{a}^{b} {e}^{i ( ω t + β )} d t \vert = \vert \frac{{e}^{i a ω} - {e}^{i b ω}}{ω} \vert \leq \frac{2}{ω}$$

where [a, b]∈I is the boundary condition and the result also holds if on the open interval (a, b). For an arbitrary positive real number ∈>0, there exists a unit step function s(t), referred to [3, p 264], such that

$${\int }_{I} \vert g ( t ) - s ( t ) \vert d t < \frac{ɛ}{2}$$

Now there is a positive real number M such that if ω≧M,

$$\vert {\int }_{I} s ( t ) {e}^{i ( ω t + β )} d t \vert < \frac{ɛ}{2} \qquad ( 56 )$$

holds. Therefore, we have

$$\begin{matrix}\vert {\int }_{I} g ( t ) {e}^{i ( ω t + β )} d t \vert \leq \vert {\int }_{I} ( g ( t ) - s ( t ) ) {e}^{i ( ω t + β )} d t \vert + \\ \vert {\int }_{I} s ( t ) {e}^{i ( ω t + β )} d t \vert \leq \\ {\int }_{I} \vert g ( t ) - s ( t ) \vert d t + \frac{ɛ}{2} < \frac{ɛ}{2} + \frac{ɛ}{2} \\ = ɛ\end{matrix} \qquad ( 57 )$$

i.e., (54) or (55) is verified and hold.

According to the Riemann-Lebesgue lemma, the equation (53) or (55) and (54), as the frequency ω approaches to ∞ which means

ω>>0
then

$${lim}_{ω \to ∞} {\int }_{I} g ( t ) {e}^{i ( ω t + β )} d t = 0 \qquad ( 58 )$$

The equation (58) is a foundation of the energy dissipation. For removing any destructive energy component, (58) tells us the truth whatever the frequencies are produced by the harmonic and subharmonic waveforms and completely “damped” out by the ultra-high frequency modulation.

Observing (58), the function g(t) is an amplitude of power which is the amplitude-frequency dependent and seen the book [23, Chapter 3, 4, 5, 6]. It means if the higher frequency ω produced, the more g(t) is attenuated. When moving the more higher frequency, the energy of (58) is the more rapidly diminished. We conclude that a large part of the power has been dissipated to the excited frequency ω fast drifting across the board of each reasonable resonant point, rather than transferred into the thermal energy (heat). After all, applying the energy to a system periodically causes the ω to be drifted continuously from low to very high frequencies for the energy absorbing and dissipating. Again removing the energy, the frequency rapidly returns to the nominal state. It is a fast recovery feature. That is, this system can be performed and quickly returned to the initial states periodically.

As the previous described, realized that the behavior of the frequency getting high as increasing the amplitude of energy and vice versa, expressed as the form of

ω=ω(g(t)) (59)

The amplitude-frequency relationship as (59) which induces the adaptation of system. It means which magnitude of the energy produces the corresponding frequency excitation like as a complex damper function (50).

### REFERENCES

[1] Nicholas Minorsky. Nonlinear oscillations. Van Nostrand, New York., http://www.alibris.com, 1962.
[2] Alberto Abbondandolo. Morse Theory for Hamiltonian Systems. CRC Press., http://www.crcpress.com/, 2000.
[3] Tom M. Apostol. Mathematical Analysis. Addison-Wesley Publishing Company., http://www.aw-bc.com/, 2nd edition, 1975.
[4] V. I. Arnold. Ordinary Differential Equations. MIT Press., http://www.mitpress.com/, 1973.
[5] V. I. Arnold. Geometrical Methods in the Theory of Ordinary Differential Equations. Springer-Verlag., http://www.springer-ny.com/, 2nd edition, 1988.
[6] V. I. Arnold. Theory of Singularities and its Applicatoins., volume 1. American Mathematicial Society., http://www.ams.org/, 2nd edition, 1990.
[7] Donald R. Askeland. The Science and Engineering of Materials. PWS Publishers., alternate edition, 1985.
[8] J. Balakrishnan. A geometric framework for phase synchronization in coupled noisy nonlinear systems. Physical Review E, 73:036206, 2006.
[9] Timoteo Carletti and Gabriele Villari. A note on existence and uniqueness of limit cycles for li
   'enard systems, 2003.
[10] V. K. Chandrasekar, M. Senthilvelan, and M. Lakshmanan. An unusual li
   'enard type nonlinear oscillator with properties of a linear harmonic oscillator, 2004.
[11] E. T. Copson. An introduction to the theory of functions of a complex variable. Oxford University Press., http://www.amazon.com/, 4th edition, 1948.
[12] M. C. Cross, A. Zumdieck, Ron Lifshitz, and J. L. Rogers. Synchronization by nonlinear frequency pulling. Physical Review Letters, 93:224101, 2004.
[13] R. Wong F. Cuker. The Collected Papers of Stephen Smale., volume 3. Singapore University Press., http://www.worldscibooks.com/mathematics, 2000.
[14] H. Giacomini and S. Neukirch. On the number of limit cycles of the lienard equation, 1997.
[15] Jaume Gine and Maite Grau. A note on “relaxation oscillators with exact limit cycles”, 2005.
[16] John Guckenheimer and Philip Holmes. Nonlinear Oscillations, Dynamical Systems, and Bifurcations of Vector Fields. Springer-Verlag., http://www.springer-ny.com/, 1997.
[17] Ernest A. Guillemin, editor. Synthesis of Passive Networks: Theory and Methods Appropriate to the Realization and Approximation Problems. John Wiley and Sons., 1957.
[18] Edward H. Hellen and Matthew J. Lanctot. Nonlinear damping of the lc circuit using anti-parallel diodes, 2006.
[19] Arthur R. Von Hippel. Dielectrics and Waves. A John Wiley & Sun, Inc., http://www.wiley.com, 1954.
[20] Arthur Von Hippel. Dielectric Materials and Applications. Artech House Publishers., http://www.artechhouse.com, 1995.
[21] Morris W. Hirsh and Stephen Smale. Differential Equations, Dynamical Systems and Linear Algebra. Academic Press., http://www.academicpress.com/, 1974.
[22] Thomas J. R. Hughes. Jerrold E. Marsden. Mathematical Foundations of Elasticity. Prentice-Hall, Inc., http://www.doverpublications.com/, 1984.
[23] D. W. Jordan and Peter Smith. Nonlinear Ordinary Differential Equations. Oxford University Press., http://www.oup.co.uk/academic/, 3rd edition, 1999.
[24] Yitzhak Katznelson. An Introduction to Harmonic Analysis. Cambridge University Press, http://www.amazon.com/, 2nd edition, 1968.
[25] Alexandra S. Landsman and Ira B. Schwartz. Predictions of ultra-harmonic oscillations in coupled arrays of limit cycle oscillators, 2006.
[26] Serge Lang. Complex Analysis. Springer-Verlag., http://www.springer.de/phy/books/ssp, 4th edition, 1999.
[27] Jose-Luis Lopez and Ricardo Lopez-Ruiz. The limit cycles of lienard equations in the strongly non-linear regime, 2002.
[28] Jose-Luis Lopez and Ricardo Lopez-Ruiz. Approximating the amplitude and form of limit cycles in the weakly non-linear regime of lienard systems, 2006.
[29] Jose-Luis Lopez and Ricardo Lopez-Ruiz. The limit cycles of lienard equations in the weakly nonlinear regime, 2006.
[30] A. J. Moulson and J. M. Herbert. Electroceramics: Materials, Properties, Applications. Wiley and Sun Ltd., http://www3.wileye.com, 2nd edition, 2003.
[31] Peter J. Olver. Applications of Lie Groups to Differential Equations. Springer-Verlag., http://www.springer-ny.com/, 1993.
[32] Lawrence Perko. Differential Equations and Dynamical Systems. Springer-Verlag, New York, Inc., http://www.springer-ny.com, 3rd edition, 2000.
[33] Jerrold E. Marsden. Ralph Abraham. Foundations of Mechanics. Perseus Publishing., http://www.perseusbooksgroup.com/front.html, 2nd edition, 1984.
[34] Michael Reed and Barry Simon. Methods of Modern Mathematical Physics: Fourier Analysis, Self-Adjointness., volume 2. Academic Press., http://www.academicpress.com, 1975.
[35] Michael Reed and Barry Simon. Methods of Modern Mathematical Physics: Analysis of Operators., volume 4. Academic Press., http://www.academicpress.com, 1978.
[36] Michael Reed and Barry Simon. Methods of Modern Mathematical Physics: Scattering Theory., volume 3. Academic Press., http://www.academicpress.com, 1979.
[37] George F. Simmons. Introduction to Topology and Modern Analysis. McGRAW-HILL Inc., http://books.mcgraw-hill.com, 1963.
[38] Ali Taghavi. On periodic solutions of lienard equations, 2004.
[39] Shoukai Wang and D. D. L. Chung. Apparent negative electrical resistance in carbon fiber composites, 1999.
[40] E. T. Whittaker and G. N. Watson. A Course of Modern Analysis. Cambridge Mathematical Library., http://www.cambridge.org, 4th edition, 1927.
[41] Matthew Sands. WRichard P. Feynman, Robert B. Leighton. Feynman Lectures On Physics: The Complete And Definitive Issue., volume 3. Addison Wesley Publishing Company., http://www.aw-bc.com, 2nd edition, 1964.
[42] A. David Wunsch. Complex Variables with Applications. Addison-Wesley Publishing Company Inc., http://www.aw-bc.com/, 1983.

### SUMMARY OF THE INVENTION

It's a first objective is to provide a new PWM controller for power switching circuit.

It's a second objective to provide a power switching circuit employing the new PWM controller, which has very wide bandwidth, better capability to deal with bigger power and better capability to increase chances to impedance-match with loading.

It's a third objective to provide a backward current decoupler for driving a loading so that the better capability to increase chances to impedance-match with loading can be achieved.

It's a fourth objective to provide a new sensor based on the backward current decoupler for being sensitive with temperature field, magnetic field flux intensity, optical field intensity, electrical field such as voltage, current, frequency or electrical power, mechanical field such as magnitude of force, vibration force or any combinations of them.

It's a fifth objective is to provide a new inductor with widely variable inductance.

It's a sixth objective is to provide a new capacitor with widely variable capacitance.

It's a seventh objective is to provide a new resistor with widely variable resistance.

### BRIEF DESCRIPTION OF THE DRAWINGS

FIG. 1 has shown a parallel oscillator;

FIG. 2 has shown a serial oscillator;

FIG. 3 has shown the function F(x) and a trajectory Γ of Liénard system;

FIG. 4 has shown the impedance function F(x) is independent of the initial condition setting;

FIG. 5 a capacitor C decomposed into an ideal capacitor Cᵢ, a series parasitic resistor Rₛ;

FIG. 6a has defined a symbol of a backward current decoupler;

FIG. 6b has shown a two-lamina composite in top view;

FIG. 6c has shown the two-lamina composite of FIG. 6b in side view;

FIG. 6d has shown a multi-lamina composite in side view;

FIG. 6e has shown the multi-lamina composite of FIG. 6d in top view;

FIG. 6f has shown a PNDR junction formed by two fibers;

FIG. 6g has shown a PNDR junction formed by two fibers;

FIG. 6h has shown a PPNDR junction formed by two fibers;

FIG. 6i has shown a three-layer thin films;

FIG. 6j has shown the three-layer thin films of FIG. 6i rolled into a shape of a fiber;

FIG. 6l has shown two loops formed in the two-lamina composite;

FIG. 6m has shown a capacitor matrix in side view;

FIG. 6n has shown the capacitor matrix of FIG. 6m in top view;

FIG. 6o has shown a six-lamina composite in side view;

FIG. 6p has shown the six-lamina composite of FIG. 6o in top view;

FIG. 6q has shown a 3×3 sensor matrix;

FIG. 6r has shown a PPNDR junction formed by two fibers;

FIG. 7a has shown a flow chart to demonstrate a new PWM controller;

FIG. 7b has shown a waveform diagram to interpret the PWM controller of FIG. 7a;

FIG. 8a has shown a power switching circuit;

FIG. 8b has shown the power switching circuit of FIG. 8a if the power source of FIG. 8a is a dc battery;

FIG. 8c has shown the result after the following replacements of the switching circuit of FIG. 8b of which the switches are designated by power transistors, the wide-band dampers in all the Lenz circuits are respectively realized by a PDR and NDR devices electrically connected in series, the action/reaction isolation devices in all the Lenz circuit are respectively realized by a capacitor and the coupler is realized by a transformer.

FIG. 8d has shown a loading electrically connecting with the power switching circuit of FIG. 8a through a diode;

FIG. 8e has shown a plurality of paralleling switches in the power switching circuit of FIG. 8a;

FIG. 8f has shown a fault detection circuit equipped with the first and/or second switches of the power switching circuit of FIG. 8a;

FIG. 8g has shown a fault detection circuit equipped with each paralleling switch of FIG. 8e;

FIG. 8h has shown a magnetic sensor, an optical sensor and a thermal sensor respectively disposed neighboring the inductor and loading of the power switching circuit of FIG. 8d, and the sensors are electrically connecting with the second terminal of the PWM controller;

FIG. 8i has shown a 3×3 array of nine backward current decouplers each of which drives a loading; and

FIG. 8j has shown a waveform diagram to interpret the power switching circuit of FIG. 8a.

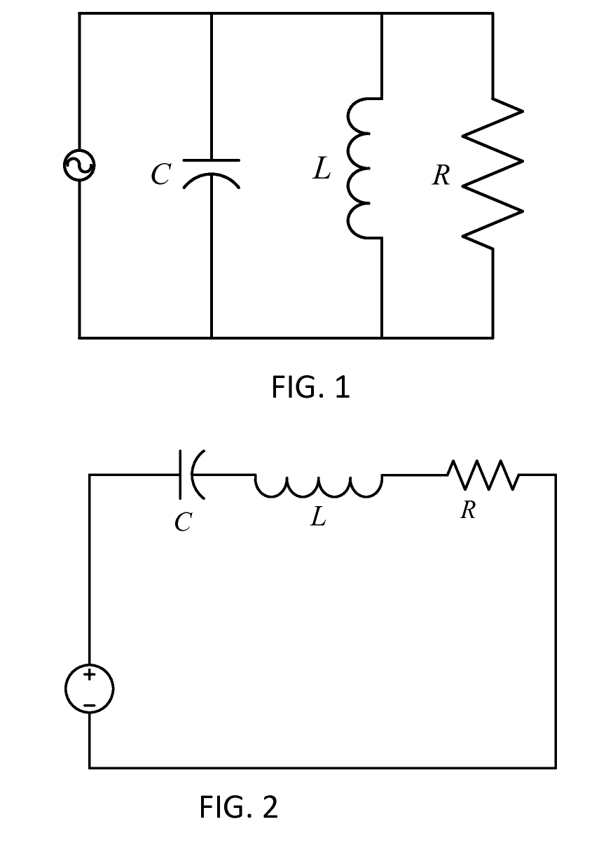

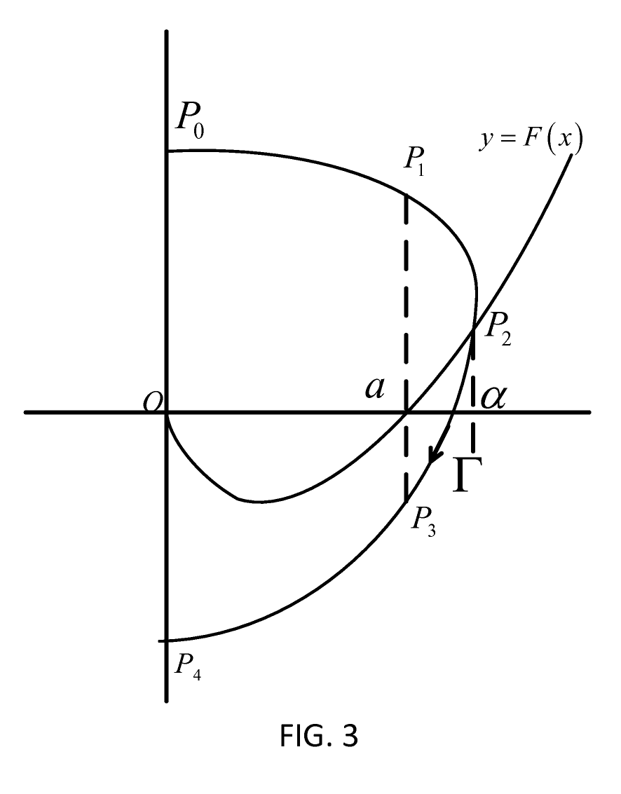

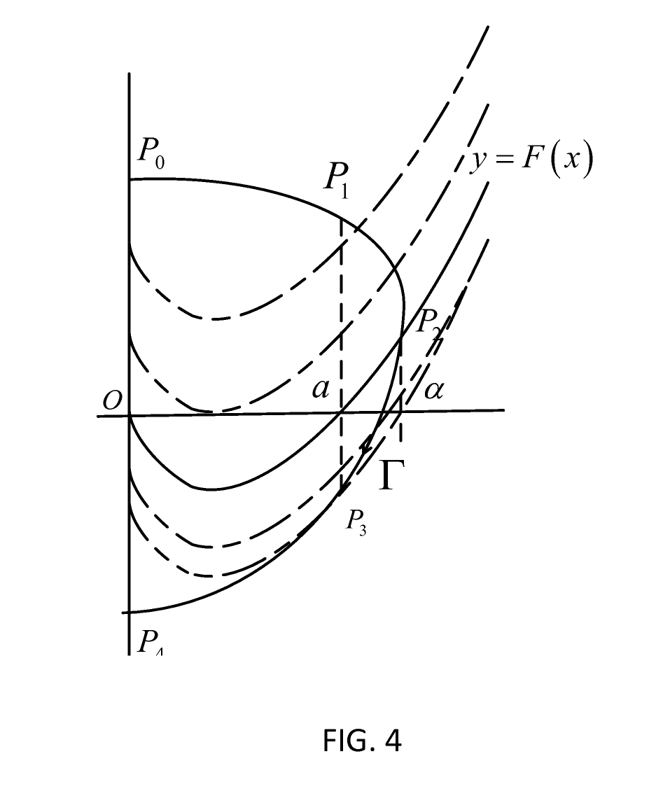

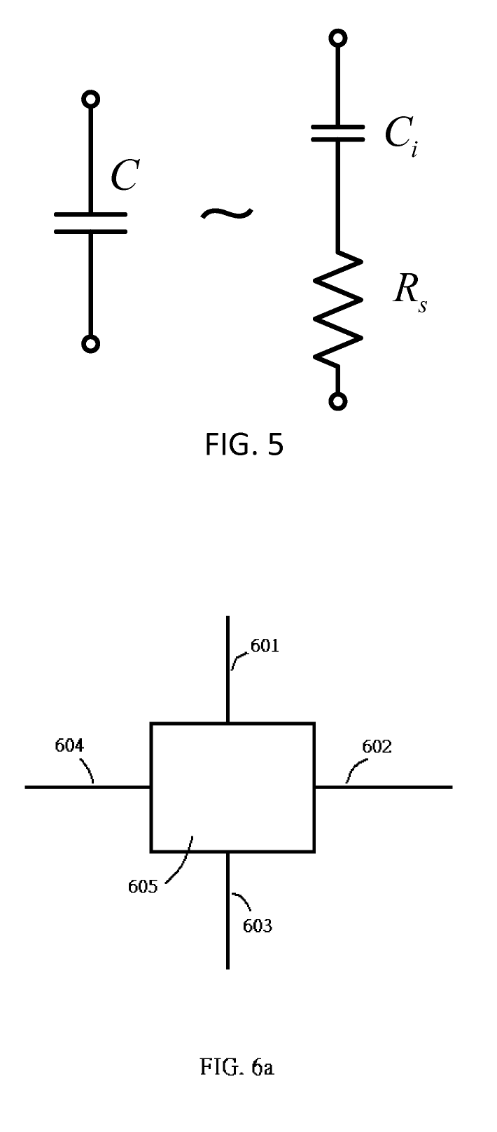

### DETAILED DESCRIPTION OF THE INVENTION

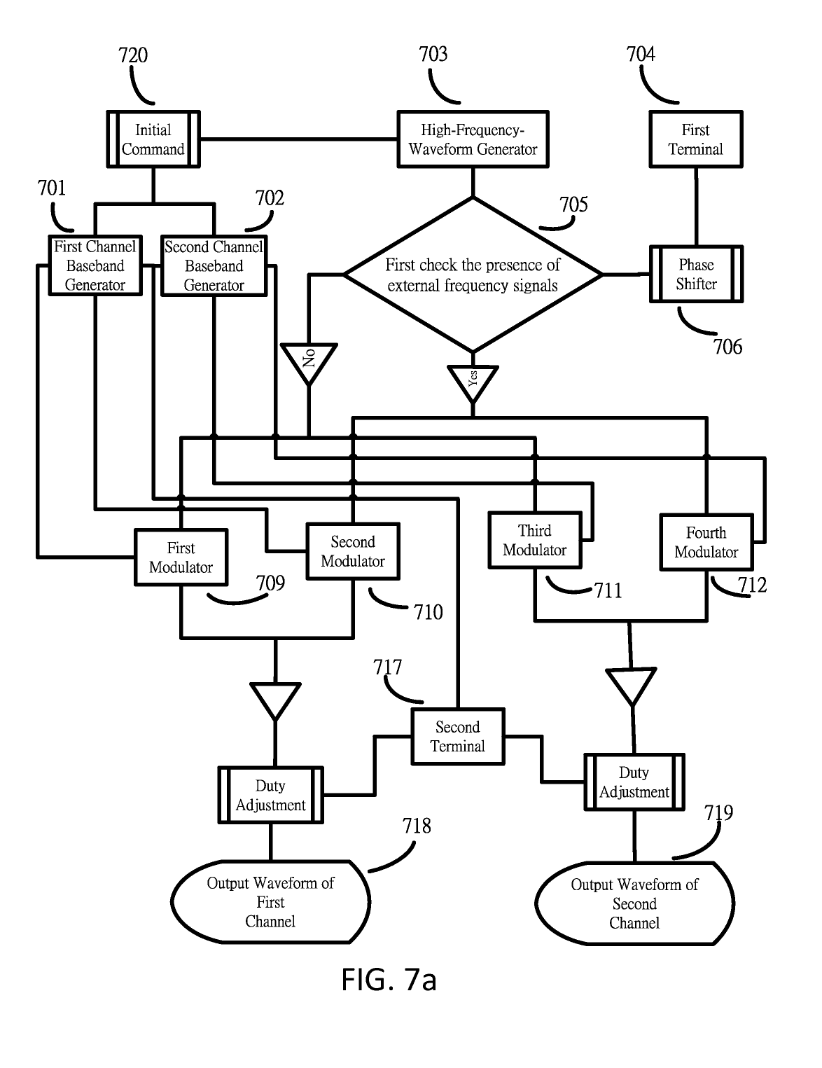

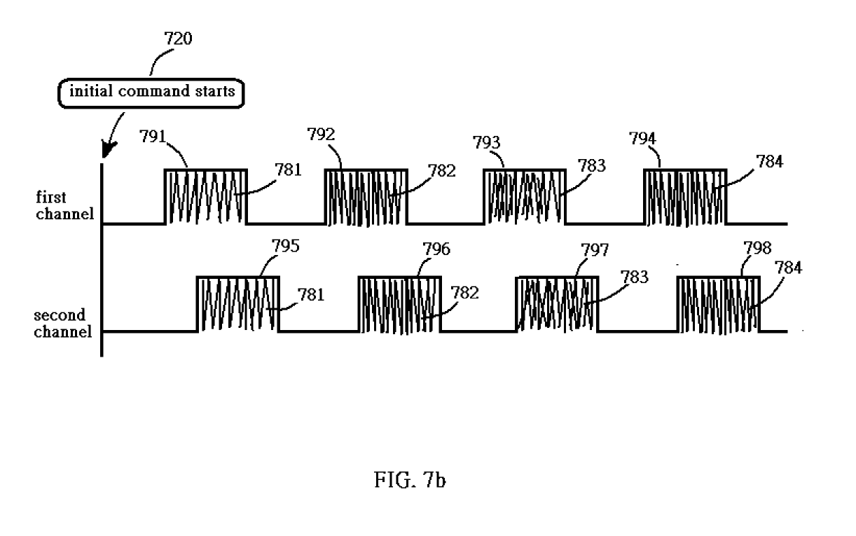

A new PWM controller will be employed in an inventive power switching circuit so that the PWM controller is discussed first. A new PWM controller is operated by a flow chart shown in FIG. 7a. Both a first channel baseband generator 701 and a second channel baseband generator 702 are for generating baseband waveform respectively as baseband waveform of a first channel and baseband waveform of a second channel. The waveforms respectively generated by the first and second channel baseband generators 701, 702 may be different.

A high-frequency-waveform generator 703 is for generating high-frequency waveforms. A first and second terminals 704, 717 of the PWM controller are for receiving external signals respectively as external signal at the first terminal and external signal at the second terminal. A first checker 705 is for checking if any external signal appearing at the first terminal 704. A first, second, third and fourth modulators 709, 710, 711 and 712 are for frequency-modulating two waveforms. A phase shifter 706 is for shifting phase.

A PWM controller is operated by steps as follow shown in the flow chart of FIG. 7a for m≧1:

generating an m^{th} baseband waveform of a first channel, a m^{th} baseband waveform of a second channel and generating an m^{th} high-frequency waveform;

checking the presence of an external signal at a first terminal;

modulating the m^{th} high frequency waveform with the m^{th} baseband waveform of the first channel and the m^{th} baseband waveform of the second channel if no external signal at the first terminal is checked;

phase-shifting the external signal at the first terminal, and modulating the external signal at the first terminal after the phase-shifting step with the m^{th} baseband waveform of the first channel and the m^{th} baseband waveform of the second channel, and stopping generating a m+1^{th} high-frequency waveform, if the presence of the external signal at the first terminal is checked;

adjusting a duty cycle of the modulated waveform of the first channel and a duty cycle of the modulated waveform of the second channel; and

outputting the m^{th} output waveform of the first channel and the m^{th} output waveform of the second channel after the duty cycle-adjusting step. An external signal of a second terminal checks with the m^{th} output waveform of the first channel and the m^{th} output waveform of the second channel after the duty cycle-adjusting step to further adjust a m+1^{th} baseband waveform of the first channel and a m+1^{th} baseband waveform of the second channel.

For example, if m=1 when initial command 720 starts, the first channel baseband generators 701, the second channel baseband generator 702 and the high-frequency-waveform generator 703 respectively start to generate a first baseband waveform of a first channel, a first baseband waveform of a second channel and a first high-frequency waveform, and, the first and third modulators 709, 711 respectively modulate the first baseband waveform of the first channel and the first baseband waveform of the second channel with the first high-frequency waveform. The waveforms respectively out of the first and third modulators 709, 711 after the modulation step can be further for duty adjustments.

The waveforms after the duty adjustment step will be output respectively shown as a first output waveform of the first channel 718 and a first output waveform of the second channel 719, and the two output waveforms will be checked with external signal received at the second terminal to respectively further adjust a second baseband waveform of the first channel and a second baseband waveform of the second channel respectively generated by the first channel baseband generator 701 and the second channel baseband generator 702 if needed.

For example, If m=2 an external signal at a first terminal is checked then phase-shifts the external signal at the first terminal, and modulates the external signal at the first terminal after the phase-shifting step with the 2^{th} baseband waveform of the first channel and the 2^{th} baseband waveform of the second channel, and stops generating a 3^{th} high-frequency waveform, and then adjusts a duty cycle of the modulated waveform of the first channel and a duty cycle of the modulated waveform of the second channel; and outputs the 2^{th} output waveform of the first channel and the 2^{th} output waveform of the second channel after the duty cycle-adjusting step. An external signal of a second terminal checks with the 2^{th} output waveform of the first channel and the 2^{th} output waveform of the second channel after the duty cycle-adjusting step to further adjust a 3^{th} baseband waveform of the first channel and a 3^{th} baseband waveform of the second channel.

Assuming that the first high-frequency waveform only appears at the first waveform of the first and second channels and the external signal at the first terminal will be input at each waveform after the first waveform of the first and second channels, and assuming that there is no external signal at the second terminal. A waveform diagram shown in FIG. 7b will be helpful to interpret the procedure of the embodiment above. FIG. 7b has shown that the first high-frequency waveform 781 is modulated with the first waveform of the first channel 791 and the first waveform of the second channel 795, the first external signal at the first terminal after phase-shifting 782 is modulated with the second waveform of the first channel 792 and the second waveform of the second channel 796, the third external signal at the first terminal after phase-shifting 783 is modulated with the third waveform of the first channel 793 and the third waveform of the second channel 797 and the fourth external signal at the first terminal after phase-shifting 784 is modulated with the third waveform of the first channel 794 and the third waveform of the second channel 798.

The two output waveforms of the first and second channels 718, 719 of the PWM controller of FIG. 7a will be employed for controlling the on/off switchings of two switches of a power switching circuit.

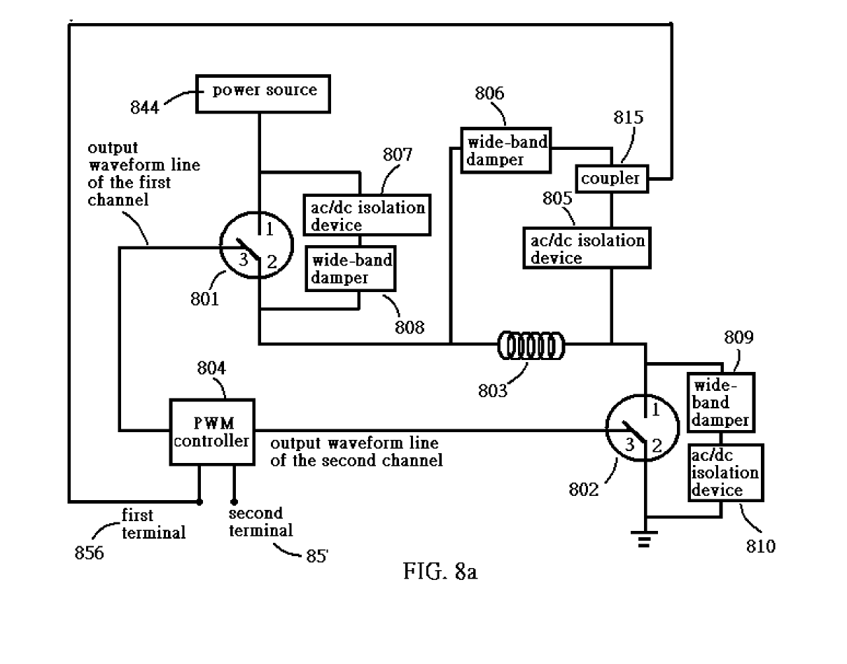

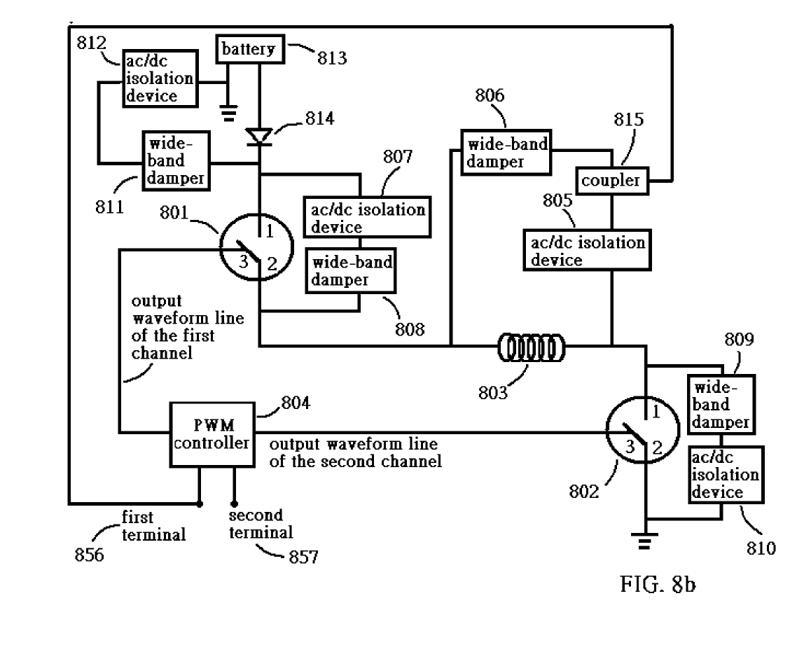

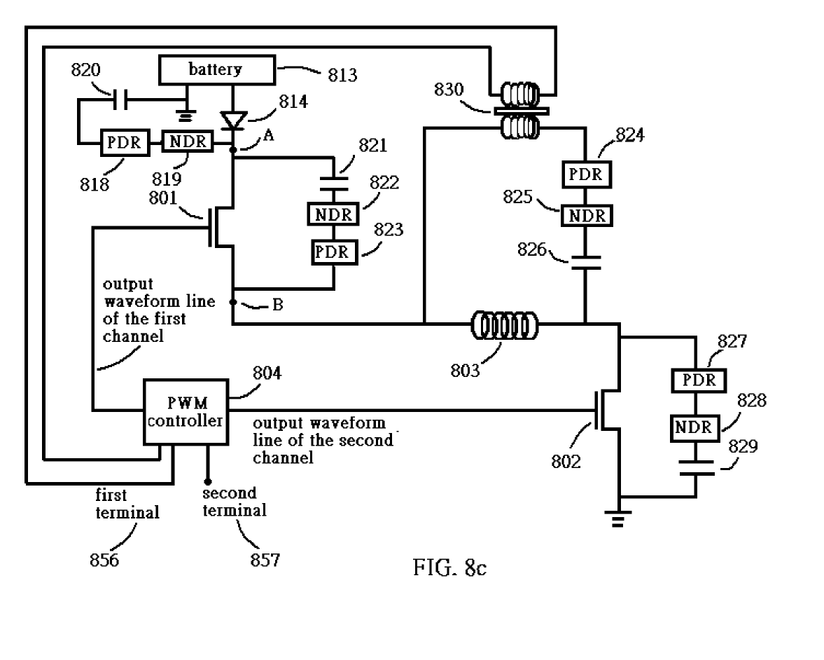

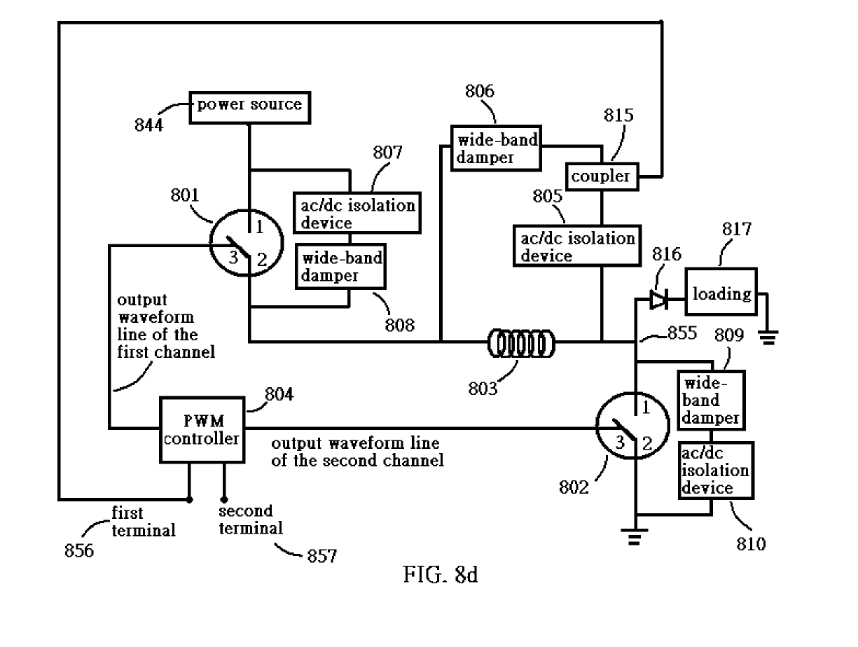

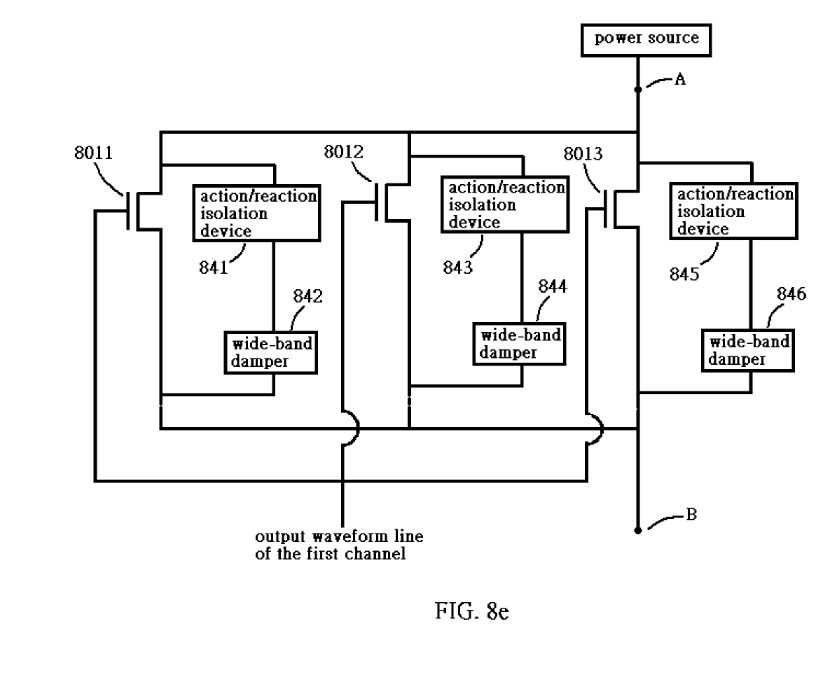

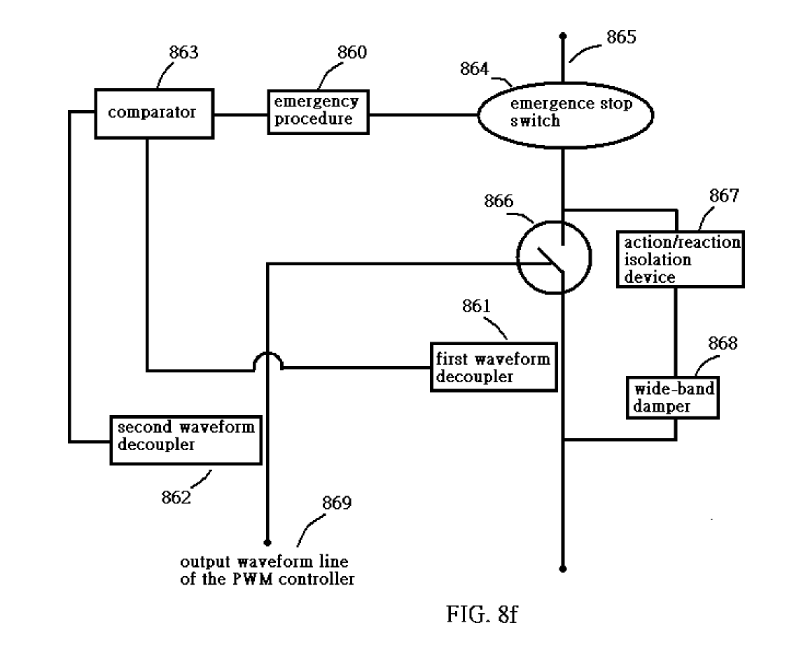

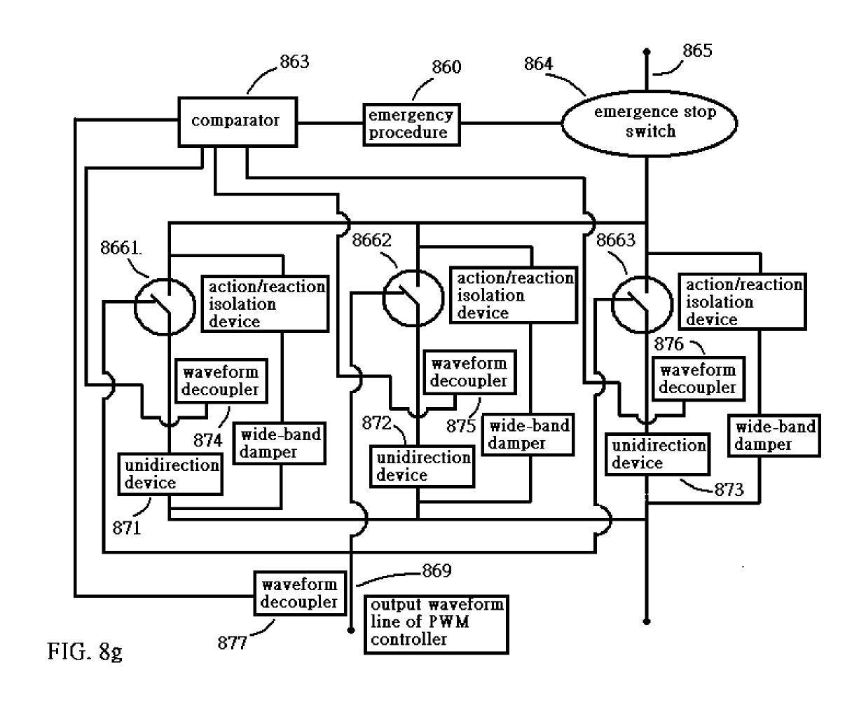

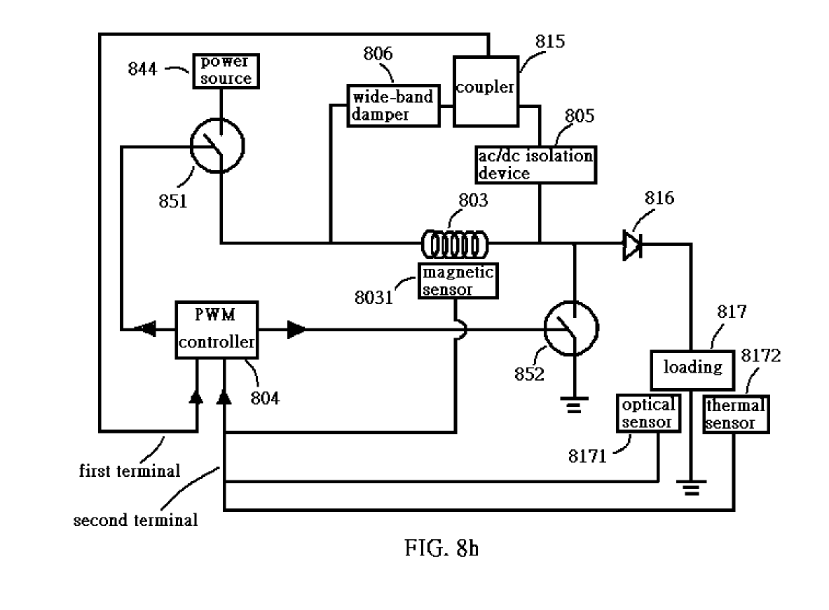

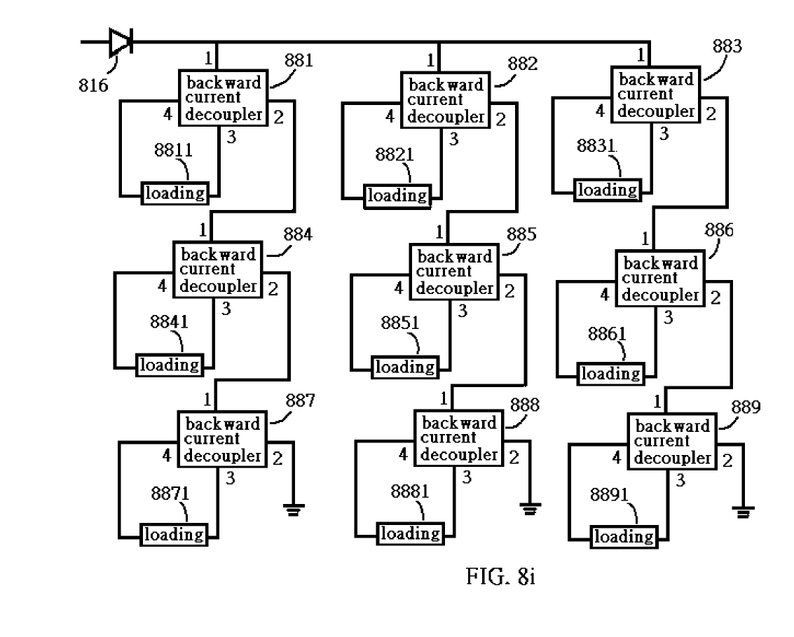

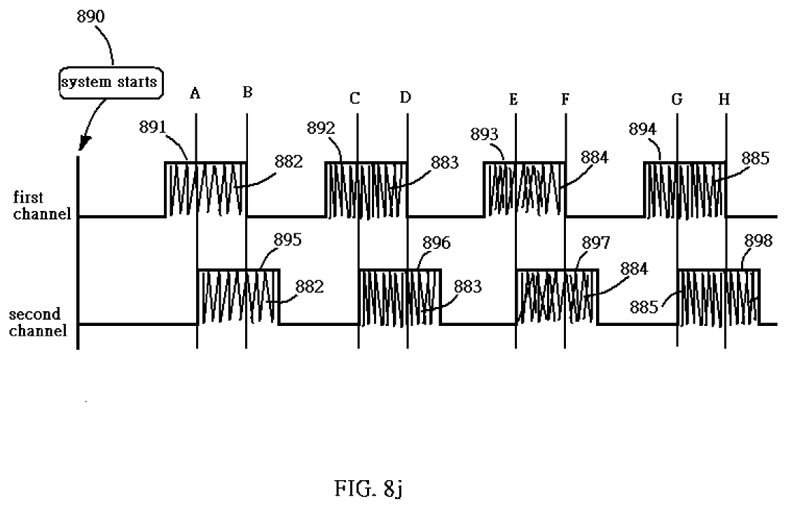

An inventive power switching circuit employing the PWM controller of FIG. 7 has been shown in FIG. 8a. The switching circuit comprises a power source 844, a first switch 801, a second switch 802, an inductor 803, a first Lenz circuit electrically connected in parallel with the first switch 801, a second Lenz circuit electrically connected in parallel with the second switch 802, a third Lenz circuit electrically connected in parallel with the inductor 803, the PWM controller 804 of FIG. 7 of which the two output waveforms respectively electrically connected with the first and second switches 801, 802 and a coupler 815 disposed in the third Lenz circuit in parallel with the inductor 803 for feeding-back the waveforms of Lenz current into the PWM controller 804 through its first terminal 856 of which the power source 844, first switch 801, inductor 803 and second switch 802 are electrically connected in series with each other in this order. The output waveform lines of the first channel and second channel of the PWM controller 804 are respectively electrically connected with first and second switches 801, 802 for respectively controlling the on/off switchings of the first and second switches 801, 802.

The first and second switches 801, 802 respectively comprise a first, second and third terminals of which the electrical connection and disconnection of the first and second terminals respectively marked by 1 and 2 are controlled by the signal received on their respective third terminal marked by 3. The first and second output waveforms of the PWM controller 804 respectively electrically connect the third terminals respectively of the first and second switches 801, 802 for controlling the electrical connection and disconnection of the first and second terminals of the two switches 801, 802. Either side of the main loading, the inductor 803, of the power switching circuit is taken as output.

The switch is not limited, for example, the switch can be “power electronic device” such as a power transistor, which can duplicate the output waveform from the PWM controller received on its third terminal, or a SCR, which can not duplicate the waveforms from the PWM controller received on its third terminal. For convenience, a switch which can duplicate the waveforms received on its third terminal is called duplicatable switch in the present invention. A switch which can not duplicate the waveforms received on its third terminal is called non-duplicatable switch in the present invention. It's obviously, the power transistor is a duplicatable switch and SCR is a non-duplicatable switch. And further, the power switching circuit of FIG. 8a should contain at least a duplicatable switch to duplicate the waveforms from the PWM controller into the power switching circuit.

Also shown in FIG. 8a, the PWM controller 804 has a first and second terminals 856, 857 for receiving external signals as revealed by the section of the PWM controller of FIG. 7a above.

The following explains the Lenz circuits of the power switching circuit. Each Lenz circuit comprises a wide-band damper and an action/reaction isolation device electrically connected in series.

The term “action” appearing in the “action/reaction isolation device” means the power switching circuit is in closed loop with both the two switches 801, 802 are in on state so that current can flow through the power switching circuit. When any one of the two switches 801, 802 is in off state after the “action” then the power switching circuit is open and “reaction” to the “action” can happen in a time period after the “action”.

When the power switching circuit is in closed loop the “action” happens and if the power switching circuit is opened the “reaction”, Lenz current, to the “action” happens.

The known Lenz current, which is opposite to the current from the power source, is an example of the “reaction”. An action/reaction isolation device in a Lenz circuit is for prohibiting the current from the power source, an action, from flowing through the Lenz circuit but allowing Lenz current, the reaction to the action, to flow the Lenz circuit. For example, if the power source is a dc source in the embodiment of FIG. 8a, the action/reaction isolation device is for blocking the dc from flowing through the Lenz circuit but allowing the opposite ac Lenz current to pass the Lenz circuit. In the embodiment of dc source, the action/reaction isolation device can also be called ac/dc isolation device. It's noticed that the Lenz circuit is always to be in parallel with the needed target device.

The wide-band damper is for dissipating or stablizing the Lenz power and a good wide-band damper should have very wide bandwidth which is broad enough to cover that of the Lenz current to dissipate significant Lenz power flowing through the Lenz circuit.

The power switching circuit has three loadings, two switches 801, 802 and the inductor 803, of which the inductor 803 can be viewed as the main loading. The waveform of Lenz current contains the waveforms of the frequency responses of all the loadings of the power switching circuit, and, the waveform of Lenz current will be coupled into the PWM controller 804 by the coupler 815 to be modulated with the baseband waveforms of the PWM controller 804 after phase-shifting and the output waveforms from the PWM controller will be duplicated into the power switching circuit through at least one of the first and second switches 801, 802. The waveform of the reaction “Lenz current” containing the frequency responses of all the loadings and carried in the baseband waveforms of the power switching circuit can increase the chances to find impedance matching points with the two transistors 801, 802.

The wide-band damper, action/reaction isolation device and the coupler are not limited in the present invention. An embodiment, the wide-band damper can be realized by a PDR and NDR devices electrically connected in series as revealed in the background information section. The action/reaction isolation device can be an unidirection device such as a diode or an ac/dc isolation device such as capacitor. For example, the capacitor can block dc from the battery flowing through the Lenz circuit but allow ac Lenz curent to pass the Lenz circuit. The coupler 815 is not limited, it can be a capacitive, an inductive or a resistive coupler, for example, it can be a capacitor, a transformer or a resistor.

FIG. 8b has shown the power switching circuit of FIG. 8a if the power source of FIG. 8a is a dc battery. The battery 813 also has a fourth Lenz circuit parallel to it and a diode 814 is used to protect the battery 813 from voltage surge. As same as revealed above, the fourth Lenz circuit comprises a wide-band damper and an action/reaction isolation device electrically connected in series.

FIG. 8c has shown the result after the following replacements of the switching circuit of FIG. 8b of which the switches are designated by power transistors, the wide-band dampers in all the Lenz circuits are respectively realized by a PDR and NDR devices electrically connected in series, the action/reaction isolation devices in all the Lenz circuit are respectively realized by a capacitor and the coupler is realized by a transformer.

The function of the power switching circuit of FIG. 8a can be easier interpreted by using a waveform diagram shown in FIG. 8j. When the system starts 890, the high-frequency waveform 882 generated by the first high-frequency-waveform generator in the PWM controller 804 is modulated with first baseband waveforms respectively of the first and second channels 891, 895. When any one of the two switches 801, 802 of the power switching circuit is in off state, shown as line B in FIG. 8j, the power switching circuit is opened and “reaction to the action” Lenz current occurs. The waveform of the Lenz current will be fed into the PWM controller 804 through its first terminal 856 by the coupler 815 and then phase-shifted and modulated with second baseband waveforms respectively of the first and second channels 892, 896. The carrier 883 in the second baseband waveforms respectively of the first and second channels 892, 896 seen in FIG. 8j is the waveform of the Lenz current after phase-shifting step.

Next, when any one of the two switches 801, 802 of the power switching circuit is in off state again, line D shown in FIG. 8j, the power switching circuit is opened again and “reaction to the last action” Lenz current occurs. The waveform of the Lenz current will be fed into the PWM controller 804 through its first terminal 856 by the coupler 815 and then phase-shifted and modulated with second baseband waveforms respectively of the first and second channels 893, 897. The carrier 884 in the third baseband waveforms respectively of the first and second channels 893, 897 seen in FIG. 8j is the waveform of the Lenz current after phase-shifting step. The same logic applies to the next baseband waveform, which is the fourth baseband waveform in the embodiment. The areas between the lines A and B, C and D, E and F and G and H are the times for actions, and the areas between lines B and C, D and E, and F and G are for reaction to the last action to induce Lenz current.

The power switching circuit has advantaged that the bandwidth of the power switching circuit is the multiplication of that of the two switches 801, 802 and the Lenz current so that the bandwidth of the power switching circuit can be very broad. The waveforms of Lenz current modulated into the baseband waveforms containing the frequency responses of the two switches 801, 802 have increased chances to find impedance matching points with the two switches 801, 802 so that the more accurate control of the on/off switchings of both the two switches 801, 802 can be more possibly obtained.

The output point of the power switching circuit can be taken at either side of the main loading which is the inductor 803. FIG. 8a further comprises a loading 817, which is shown in FIG. 8d, electrically connected with the low side of the inductor 803 through a second diode 816 which is for isolating the loading side from affecting the switching circuit side. The second diode 816 can be negleted if no such consideration.

It can be a problem to accurately control the on/off switchings of a power transistor under ultra-high frequency condition, and the problem gets worse for high-power power transistor. For example, a very serious problem, a power transistor can not be turned off on time once the power transistor is on, and the problem gets worse for high power condition.

A known solution to the high-power problem is to replace a high-power power transistor with a plurality of power transistors electrically connected in parallel with each other. Each paralleling power transistor can share a portion of power so that each paralleling power transistor can be the type of a lower-power power transistor, which will be easier operated under ultra-high frequency condition. The solution by the paralleling power transistors still has so-called Miller effect which describes the asynchronization of the paralleling power transistors.

The solution can be fixed by having the paralleling power transistors in the inventive power switching circuit driven by the same multi-waveform sent by the inventive PWM controller 804. An embodiment shown in FIG. 8e, the power transistor 801 of FIG. 8c is replaced by three power transistors 8011, 8012, 8013 which electrically connect the same output waveform line of the PWM controller 804. The waveform of the Lenz current flowing through the third Lenz circuit and concealing the frequency responses of all the power transistors will be modulated with the baseband waveforms of the PWM controller and the waveforms are duplicated into the switching circuit for increasing the chances to find impedance matching points with the three power transistors 8011, 8012, 8013 so that the synchronization of the three paralleling power transistors 8011, 8012, 8013 can be more possibly obtained. In other words, the Miller effect can be solved so that the synchronization of the paralleling transistors can be achieved. Each paralleling power transistor still need a Lenz circuit in parallel with it.

The Lenz circuit can be respectively embedded with each switch, the battery 813 and the inductor 803 as a protection circuit to them. It's noticed again that the first diode 814 is commonly seen in the circuit for protecting the battery 813 against the bouncing-back voltage shock. The first diode 814 can be viewed as part of the battery. The power switching circuit must contain at least a duplicatable switch to duplicate the output waveforms from the PWM controller into the switching circuit. For example, an embodiment, the duplicatable switch is a power transistor and the non-duplicatable switch is a SCR.

The power switching circuit can be equipped with fault detection circuit, and an emergency procedure can be triggered if any fault is detected by the fault detection circuit. FIG. 8f has shown the power transistor 801 of the power switching circuit of FIG. 8a equipped with a fault detection circuit. FIG. 8f has shown a first waveform decoupler 861 and a second waveform decoupler 862 respectively disposed neighboring the power line 865 of the power switching circuit and the output waveform line 869 of the PWM controller. The first and second waveform decouplers 861, 862 are respectively for decoupling the waveforms of the power line 865 and the output waveform line 869 of the PWM controller of the power switching circuit. Assuming the switch 866 is a duplicatable switch 866 which can duplicate the waveforms on the output waveform line 869 of the PWM controller into the power line 865 so that the waveforms respectively appearing on the power line 865 and the output line 869 of the PWM controller should be resemble. The two resemble waveforms can be compared through a comparator 863 and if a significant discrepancy found between the two waveforms means the duplicatable switch 866 functions abnormally so that the comparator 863 will send a control signal to trigger an emergence procedure 860 which may include an emergency stop switch 864 to cut off the power supply through the power line 865.

The duplicatable switch 866 is not limited in the invention, for example, it can be a power transistor. The fault detection circuit revealed in the embodiment of FIG. 8f can be applied to all the duplicatable switches in the power switching circuit. All the switches in the power switching circuit are suggested to adopt the type of duplicatable switch 866 to get full protection although the present invention is not so limited.

It's noticed that the first waveform decoupler 561 can be disposed contactlessly adjacent the high side or low side of the switch 866 but the waveforms respectively appeared on the high and low sides may have different phases.

The fault detection circuit can also be employed in a plurality of paralleling duplicatable switches. FIG. 8g has demonstrated three duplicatable switches respectively as a first switch 8661, a second switch 8662 and a third switch 8663 electrically connected in parallel with each other. Each paralleling duplicatable switch and an unidirection device are electrically connected in series, and the paralleling duplicatable switch and the unidirection device parallels a Lenz circuit which comprises an action/reaction isolation device and a wide-band damper electrically connected in series. The unidirection device is for keeping current to flow in one direction.

A waveform decoupler is disposed neighboring between the low side terminal of each duplicatable switch and an unidirection device. A waveform decoupled from a waveform decoupler has to be isolated from the waveform decoupled from the other waveform decoupler. Each waveform respectively decoupled from each waveform decoupler associated with each switch is sent to a comparator 863 for making comparison with a waveform decoupled from a waveform decoupler 877 disposed neighboring the output waveform line 869 of the PWM controller. If a significant discrepancy found between the two waveforms means that correspondent switch is faulty, and then the comparator 863 can send a signal to start an emergence procedure 860 which might include to cut off the power supplying by triggering the emergence stop switch 864 installed on the power line 865. The unidirection device is not limited in the present invention, for example, it can be a diode. The waveform decoupler is not limited, for example, it can be an inductor or a transformer.

The emergency procedure is not limited, for example, it may include to reset the system, stop power supplying and locate the faulty switch, etc.

The fault detection circuit can only be applied to duplicatable switch so that it's suggested that all the switches in the power switching circuit should adopt this type of switch to get full protection.

FIG. 8h has shown that the power switching circuit of FIG. 8d further comprises a magnetic sensor 8031 disposed neighboring the inductor 803, an optical sensor 8171 disposed neighboring the loading 817 if the loading 817 is a luminating device and a thermal sensor 8172 disposed neighboring the loading 817 to feed-back the sensing signals to the PWM controller 804 through its second terminal as references for adjusting the next baseband waveforms of the PWM controller. The sensor disposed neighboring the loading can also be called loading sensor such as the optical sensor and thermal sensor mentioned above.

It's noticed that the first switch 801 and second switch 802 with their respective paralleling Lenz circuit shown in FIG. 8a are respectively shrinked to a first switch 851 and second switch 852 shown in FIG. 8h for the simplicity of drawing.

The power switching circuit revealed in the invention has very wide bandwidth, better capability to deal with bigger power and better capability to increase the impedance-matching chances with loading.

The backward current decoupler revealed in the invention above can be employed into the power switching circuit for driving and increasing the impedance-matching chances with a loading or a plurality of loadings electrically connected in paralleling or/and in series. The plurality of loadings can be a very large number of loadings such as pn junction devices, for example, the pn junction device can be memory device, CPU device or LED, etc.

Each of a plurality of loadings driven by a backward current decoupler in the power switching circuit will be demonstrated. FIG. 8i has shown a 3×3 array of nine backward current decouplers each of which drives a loading. A first column circuit contains a first backward decoupler 881, a fourth backward decoupler 884 and a seventh backward decoupler 887 electrically connected in series with each other through their respective first and second terminals. A second column circuit contains a second backward decoupler 882, a fifth backward decoupler 885 and an eighth backward decoupler 888 electrically connected in series with each other through their respective first and second terminals. A third column circuit contains a third backward decoupler 883, a sixth backward decoupler 886 and a nineth backward decoupler 889 electrically connected in series with each other through their respective first and second terminals. The first, second and third column circuits are electrically connected in parallel with each other. Each loading is driven by each backward current decoupler through its third and fourth terminals. FIG. 8i has shown a first loading 8811, a second loading 8821, a third loading 8831, a fourth loading 8841, a fifth loading 8851, a sixth loading 8861, a seventh loading 8871, an eighth loading 8881 and a ninth loading 8891 respectively driven by the first 881, second 882, third 883, fourth 884, fifth 885, sixth 886, seventh 887, eighth 888 and nineth 889 backward current decouplers through their respective third and fourth terminals. The backward current decoupler is not limited, which includes PNDR and PPNDR backward current decoupler.

Current from the power switching circuit can be designed to flow through the first and second terminals of each backward current decoupler then a backward current will be induced to flow through the third and fourth terminals of each backward current.

The PNDR or PPNDR backward current decoupler has better capability to increase impedance-matching chances with its connecting loading as revealed earlier. And, further, an expective voltage can be built inside the PPNDR backward current decoupler for overcoming the bandgap of its connected loading.

The resistance variations of each loading will be impedance-matched by its connected PNDR or PPNDR backward current decoupler, which means that the plurality of the loadings have more chances to be synchronous, fast and consume the least power.

Obviously, as revealed earlier, the backward current decoupler includes the two-lamina and the multi-lamina composites revealed in the Chung's report of “apparent negative electrical resistance in carbon fiber composites”, the PNDR backward current decoupler includes the PNDR two-lamina and the PNDR multi-lamina composites, and the PPNDR backward current decoupler includes the PPNDR two-lamina and the PPNDR multi-lamina composites.

The more laminae a multi-lamina composite has the bigger resistance the multi-lamina composite will have so that an expective resistance of a multi-lamina composite can be obtained depending on the number of the laminae used. The pure resistor of a PPNDR multi-lamina composite can be equivelently functioned by using a certain number of laminae.

The PNDR and PPNDR backward current decouplers have advantaged that an opening in a first loading won't open the power supplying to a second loading electrically connected in series with the first loading. For example, shown in the embodiment of FIG. 8g, if the first loading 8811 is opened the power supply can still provide to the fourth loading 8841 and the seventh loading 8871 electrically connected in series with the first loading 8811.

The PNDR or PPNDR backward current decoupler should have very broad frequency responses to cover that of its connected loading so that the bandwidth and frequency responses of the backward current decoupler are important. The two-lamina and multi-laminae composites revealed in the Chung's report “apparent negative electrical resistance in carbon fiber composites” are very good in both the bandwidth and frequency response.

The PDR device, NDR device and pure resistor are not limited in the present invention. The backward current decoupler is not limited in the present invention. The fiber is not limited.

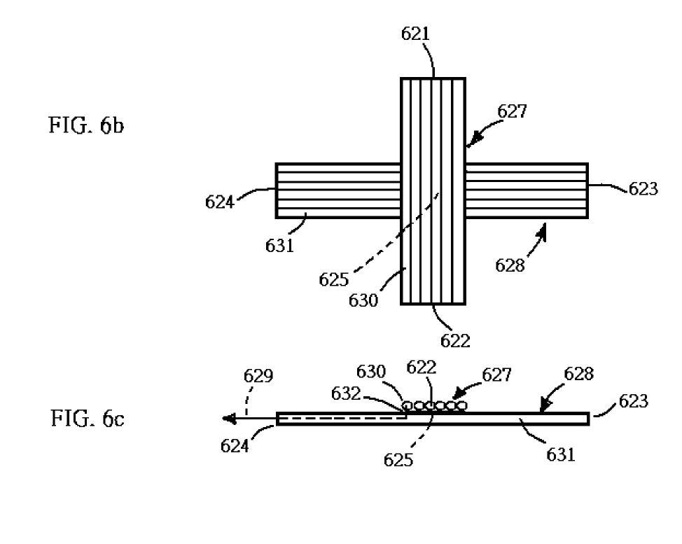

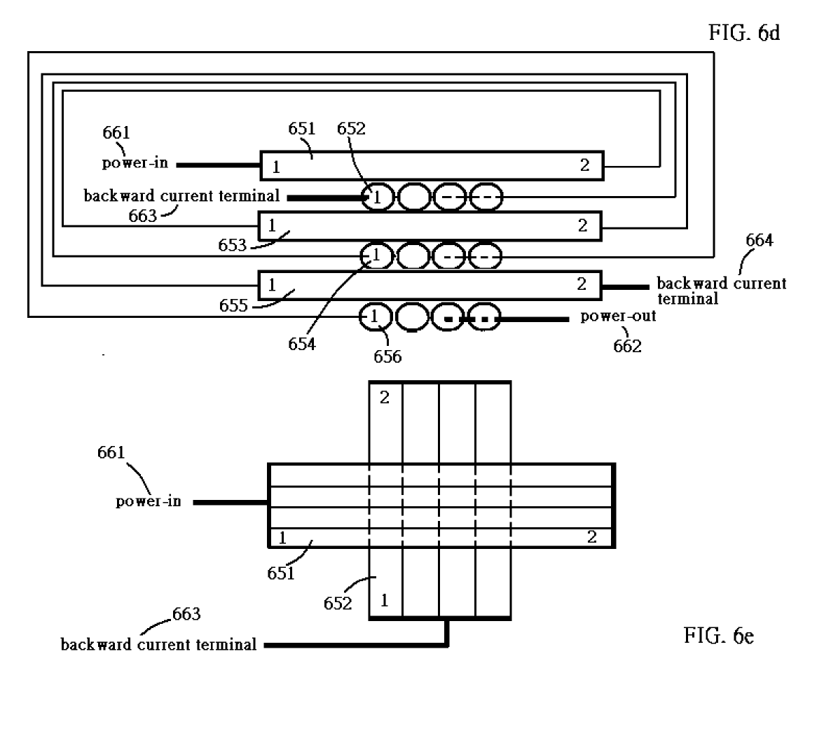

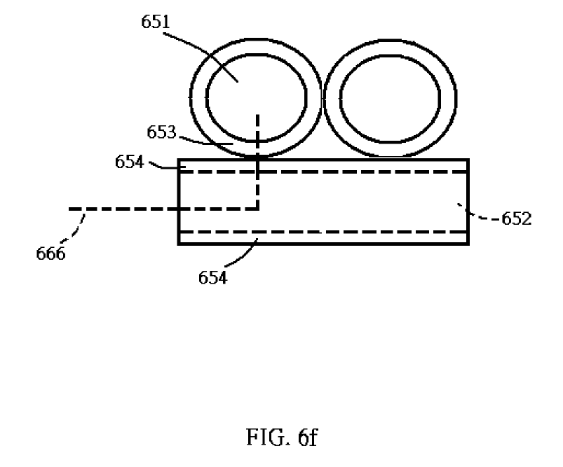

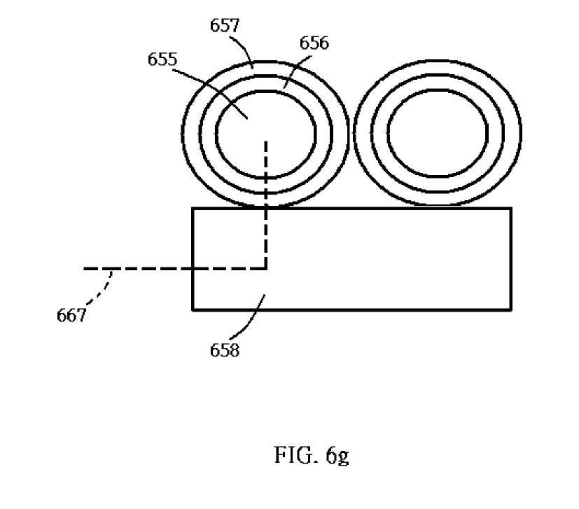

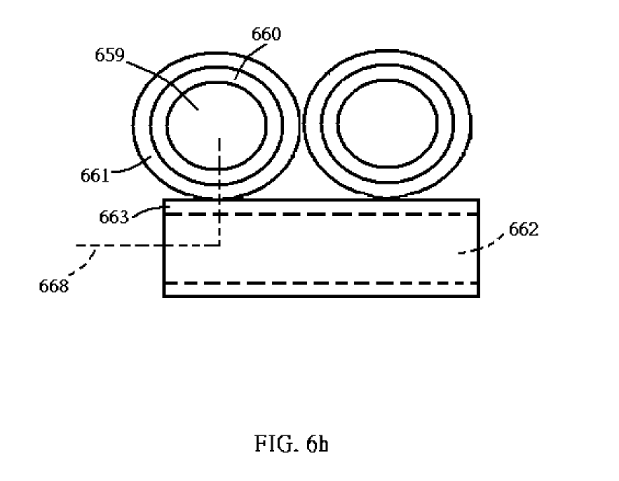

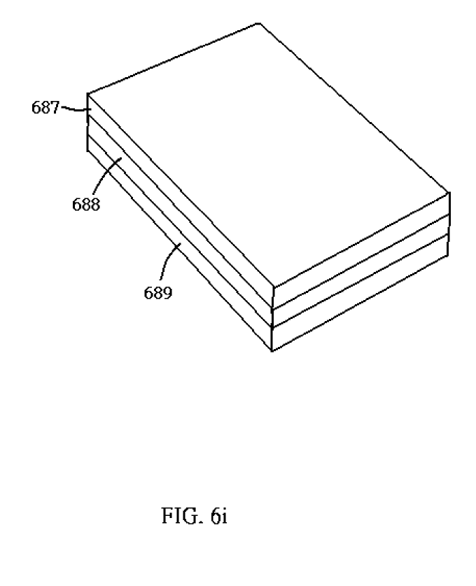

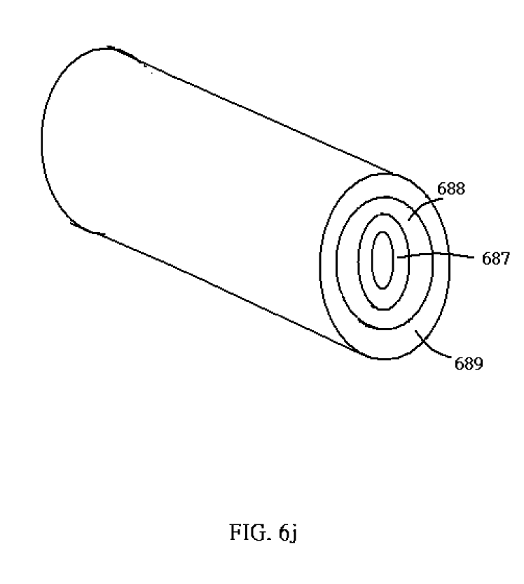

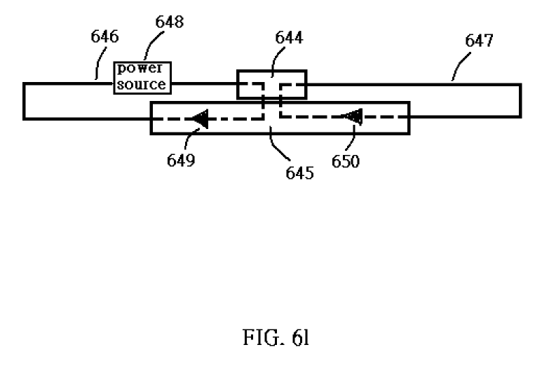

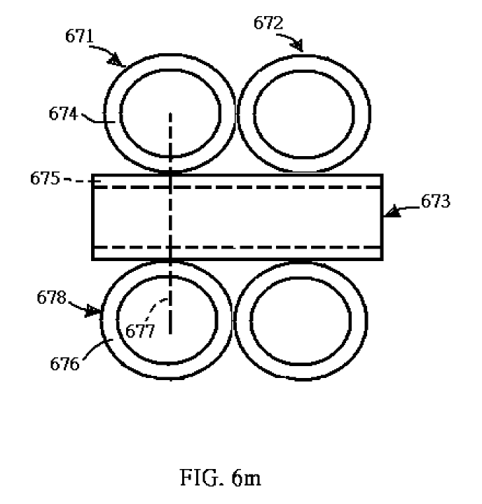

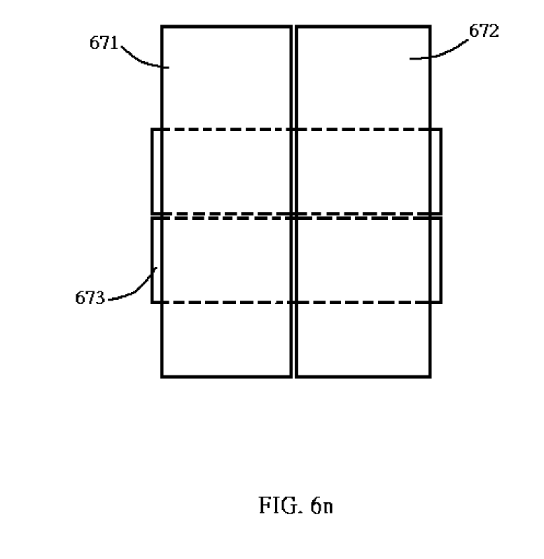

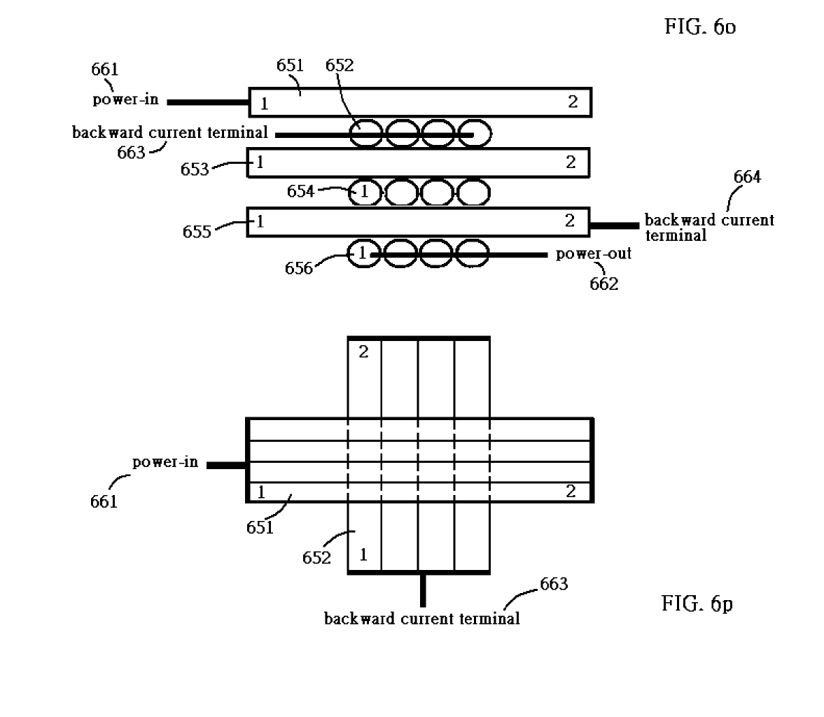

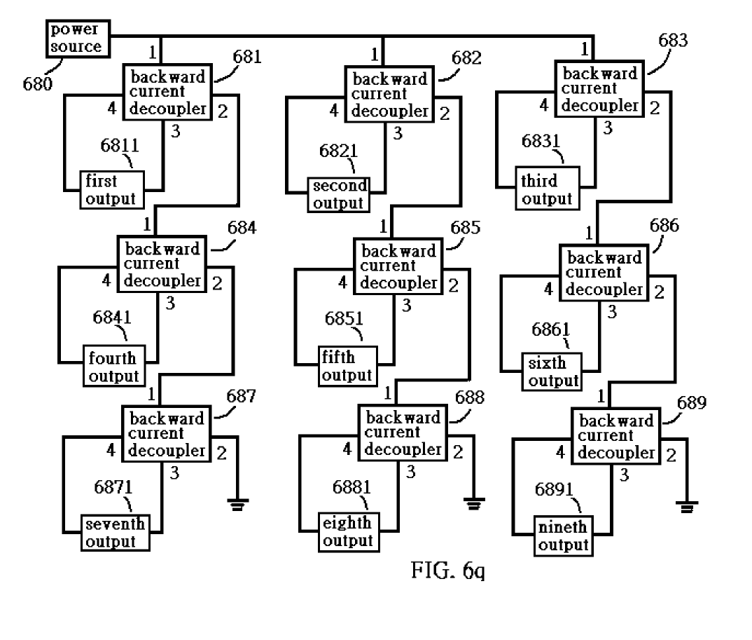

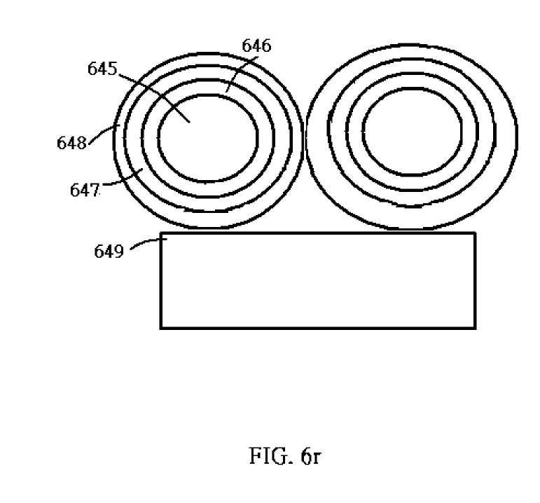

The PNDR junctions formed between two fibers respectively shown in FIGS. 6f and 6g and the PPNDR junction formed between two fibers shown in FIGS. 6h and 6r have the structure of capacitor so that the PNDR two-lamina composite, PNDR multi-lamina composite, PPNDR two-lamina composite and PPNDR multi-lamina composite made of by a plurality of PNDR junctions can be viewed as a capacitor matrix with widely variable capacitance and resistance. A capacitor with variable capacitance and a resistor with a variable resistance can be equivalent to an inductor with variable inductance according to equations (8) and (9) revealed in the background information section so that the PNDR two-lamina composite, PNDR multi-lamina composite, PPNDR two-lamina composite and PPNDR multi-lamina composite made of by a plurality of PNDR junctions can respectively be viewed as an inductor with variable inductance.

The two coupled fibers shown in FIG. 6f can be viewed as two capacitors electrically crossed with each other.

Equation (1) has revealed that capacitance of a capacitor is reversely proportional to exciting frequency and resistance so that the capacitances respectively of the PNDR two-lamina composite, PNDR multi-lamina composite, PPNDR two-lamina composite and PPNDR multi-lamina composite will dynamically vary in a very large-scale range due to violently variable resistance of the coupled PDR and NDR devices and junction effect formed between two fibers through their large area body contacts. Obviously, with more numbers of laminae and more fibers on each lamina the capacitance of the PNDR two-lamina composite, PNDR multi-lamina composite, PPNDR two-lamina composite and PPNDR multi-lamina composite will vary in a significantly large-scale range.

And further, as revealed by equations (13) and (14), the impedance functions of the PDR and NDR devices in those decouplers vary with the parameter ω, which can be temperature field T, magnetic field flux intensity B, optical field intensity I, electrical field such as voltage v, current i, frequency f or electrical power P, mechanical field such as magnitude of force F, vibration force, and so on, or any combinations of them listed above. When the PNDR two-lamina composite, PNDR multi-lamina composite, PPNDR two-lamina composite and PPNDR multi-lamina composite are affected by any field listed above then their resistance and capacitance vary and the induced backward current will reflect such influence so that those decouplers can be a sensor which includes a thermal sensor, an electrical field sensor, a magnetic field sensor, a mechanical field sensor, a vibration sensor, an optical sensor or any combinations of them. For example, if a PPNDR two-lamina composite is pressured by a force then its resistance and capacitance will vary so that induced backward current varies.

As revealed above, the PNDR backward current decoupler including the PNDR two-lamina composite and PNDR multi-lamina composite and the PPNDR backward current decoupler including PPNDR two-lamina composite and PPNDR multi-lamina composite are also sensors, capacitors, resistors with widely variable capacitance and inductors with widely variable inductance.

FIG. 6q has shown a sensor matrix made by a plurality of backward current decouplers in parallel and in series to form a sensing area. FIG. 6q has shown 9 decouplers in 3×3 matrix powered by a power source 680. Terminal 1 and terminal 2 of each decoupler are for forward current loop and terminal 3 and terminal 4 of each of the decouplers are for induced backward current loop. A sensor matrix can be used to establish a sensing area.

And further, a new p-n junction device is revealed. The term “p-n” is respectively associted with p-type and n-type semiconductor devices (or respectively p-type and n-type devices in short). Referring back to the PNDR or PPNDR junction formed between two crossed fibers respectively shown in FIGS. 6f, 6g, 6h and 6r, a new p-n junction device can be obtained if the first fiber 651 and second fiber 652 contain a p-type and a n-type devices. It means that the first fiber 651 can be a p-type or n-type device and the second fiber 652 can be the other one of the p-type or n-type device to form a p-n junction. The PNDR junction shown in FIGS. 6f and 6g is called PNDR p-n junction in the invention if the first fiber and second fiber contain a p-type and a n-type devices and the PPNDR junction shown in FIGS. 6h and 6r is called PPNDR p-n junction in the invention if the first fiber and second fiber contain a p-type and a n-type devices.

The inventive PNDR and PPNDR p-n junction devices have some advantages, for example, they have more capacitive property than current p-n junction device so that it consumes less energy, they have damper built in the junction, they have very sensitive tunneling effect due to built-in PDR and NDR devices and the heat generated in the junction can be easier conducted out through the terminals because the terminals can physically touch the junction. And further, the inventive PNDR or PPNDR p-n junction device can be interactable with temperature field T, magnetic field flux intensity B, optical field intensity I, electrical field such as voltage v, current i, frequency f or electrical power P, mechanical field such as magnitude of force F, vibration force, and so on, or any combination of them listed above so that the p-n junction device is a field-interactable device.

For example, if the p-n junction device is an optical device then it can provide better lumination with less energy consumed.

An embodiment, FIGS. 6m and 6n have shown a PNDR capacitor assembly respectively in side and top views. The PNDR capacitor assembly has three laminae each of which has two capacitors. A line 677 represents current flowing through a first capacitor 671, through a second capacitor 673 and through a third capacitor 678 for sure going through a first PDR device 674, a NDR device 675 and a second PDR device 676.

Obviously, the PNDR or PPNDR capacitor assembly can be a four-terminal backward current decoupler with very good frequency reponses and bandwidth. And further, the PNDR or PPNDR capacitor assembly can be a two-terminal capacitor assembly with any two terminals respectively on the different laminae and disregarding the other two terminals, for example, floating the other two terminals.

1. A PWM controller operated by steps of for m≧1:
generating a m^{th} baseband waveform of a first channel, a m^{th} baseband waveform of a second channel and a m^{th} high-frequency waveform;
checking the presence of an external signal at a first terminal;
modulating the m^{th} high frequency waveform with the m^{th} baseband waveform of the first channel and the m^{th} baseband waveform of the second channel if no presence of the external signal at the first terminal is checked;
phase-shifting the external signal at the first terminal, and modulating the external signal at the first terminal after the phase-shifting step with the m^{th} baseband waveform of the first channel and the m^{th} baseband waveform of the second channel, and stopping generating a m+1^{th} high-frequency waveform if the presence of the external signal at the first terminal is checked;
adjusting a duty cycle of the modulated waveform of the first channel and a duty cycle of the modulated waveform of the second channel; and
outputing the m^{th} output waveform of the first channel and the m^{th} output waveform of the second channel after the duty cycle-adjusting step.

2. The PWM controller operated by the steps of claim 1, further comprising an external signal of a second terminal, wherein the external signal of the second terminal checks with the m^{th} output waveform of the first channel and the m^{th} output waveform of the second channel after the duty cycle-adjusting step to further adjust a m+1^{th} baseband waveform of the first channel and a m+1^{th} baseband waveform of the second channel.

3. An assembly, comprising:
a power source;
a first switch;
a first Lenz circuit electrically connected in parallel with the first switch, wherein the first Lenz circuit comprises a first damper and a first action/reaction isolation device electrically connected in series;
a second switch;
a second Lenz circuit electrically connected in parallel with the second switch, wherein the second Lenz circuit comprises a second damper and a second action/reaction isolation device electrically connected in series;
a coupler;
an inductor, wherein the power source, the first switch, the inductor and the second switch are electrically connected in series with each other in the order;
a third Lenz circuit electrically connected in parallel with the inductor, wherein the third Lenz circuit comprises a third damper, a third action/reaction isolation device and the coupler electrically connected in series with each other; and
a PWM controller operated by steps of for m≧1:
generating a m^{th} baseband waveform of a first channel, a m^{th} baseband waveform of a second channel and a m^{th} high-frequency waveform;
checking the presence of an external signal at a first terminal, wherein the coupler electrically connects the first terminal;
modulating the m^{th} high frequency waveform with the m^{th} baseband waveform of the first channel and the m^{th} baseband waveform of the second channel if no presence of the external signal at the first terminal is found;
phase-shifting the external signal at the first terminal, and modulating the external signal at the first terminal after the phase-shifting step with the m^{th} baseband waveform of the first channel and the m^{th} baseband waveform of the second channel, and stopping generating a m+1^{th} high-frequency waveform if the presence of the external signal at the first terminal is found;
adjusting a duty cycle of the modulated waveform of the first channel and a duty cycle of the modulated waveform of the second channel; and
outputing the m^{th} output waveform of the first channel and the m^{th} output waveform of the second channel after the duty cycle-adjusting step, wherein the m^{th} output waveform of the first channel and the m^{th} output waveform of the second channel are respectively coupled with the first and second switches for controlling the switchings of the first and second switches.

4. The assembly of claim 3, wherein the PWM controller operated by the steps further comprises an external signal of the second terminal checks with the m^{th} output waveform of the first channel and the m^{th} output waveform of the second channel after the duty-cycle-adjusting step to further adjust a m+1^{th} baseband waveform of the first channel and a m+1^{th} baseband waveform of the second channel.

5. The assembly of claim 4, further comprising a loading electrically connected with either side of the inductor.

6. The assembly of claim 4, further comprising a diode and a loading, wherein the loading is electrically connected with either side of the inductor through the diode.

7. The assembly of claim 6, further comprising a magnetic sensor disposed neighboring the inductor and a loading sensor disposed neighboring the loading, wherein the magnetic sensor and loading sensor are electrically connected with the second terminal of the PWM controller.

8. The assembly of claim 7, wherein each of the first, second and third dampers comprises a PDR device and a NDR device electrically connected in series, and each of the first, second and third action/reaction isolation devices is a capacitor or a diode, and the coupler is a transformer, a resistor or a capacitor, and the first and second switches are respectively a power electronic device.

9. The assembly of claim 4, further comprising a plurality of switches and Lenz circuits, wherein at least a switch respectively parallels with the first switch and the second switch, and a Lenz circuit parallels with each switch and each Lenz circuit comprises a PDR device, a NDR device and a capacitor or a diode electrically connected in series with each other, and all the switches in parallel with the first switch is driven by the output waveform of the first channel of the PWM controller, and all the switches in parallel with the second switch is driven by the output waveform of the second channel of the PWM controller, and the impedance functions of the PDR device and NDR device vary with temperature field, magnetic field flux intensity, optical field intensity, electrical field such as voltage, current, frequency or electrical power, mechanical field such as magnitude of force, vibration force or any combinations of them.

10. The assembly of claim 4, further comprising a plurality of switches and Lenz circuits, wherein at least a switch respectively parallels with the first switch or the second switch, and a Lenz circuit parallels with each switch and each Lenz circuit comprises a PDR device, a NDR device and a capacitor or a diode electrically connected in series with each other, and all the paralleling switches are controlled by a same output waveform of the PWM controller, and the impedance functions of the PDR device and NDR device vary with temperature field, magnetic field flux intensity, optical field intensity, electrical field such as voltage, current, frequency or electrical power, mechanical field such as magnitude of force, vibration force or any combinations of them.

11. The assembly of claim 4, further comprising a plurality of switches, Lenz circuits, waveform decouplers, unidirection devices and a comparator, wherein at least a switch respectively parallels with the first switch and the second switch, and an unidirection device is respectively electrically connected in series with each switch, and a waveform decoupler is disposed neighboring between each unidirection device and each switch for decoupling waveform flowing between each unidirection device and each switch, and a waveform decoupler is disposed neighboring output waveform lines respectively of the first and second channels of the PWM controller for respectively decoupling the output waveforms respectively of the first and second channels of the PWM controller, and a Lenz circuit parallels with each switch and the unidirection device electrically connected in series, and each Lenz circuit comprises a PDR device, a NDR device and a capacitor or a diode electrically connected in series with each other, and all the switches in parallel with the first switch is driven by the output waveform of the first channel of the PWM controller, and each waveform decoupled from each waveform decoupler associated with the first switch and the waveform decoupled from the waveform decoupler disposed neighboring output waveform line of the first channel of the PWM controller are compared through the comparator to check if any significant discrepancy between the two waveforms, and all the switches in parallel with the second switch is driven by the output waveform of the second channel of the PWM controller, and each waveform decoupled from each waveform decoupler associated with the second switch and the waveform decoupled from the waveform decoupler disposed neighboring output waveform line of the second channel of the PWM controller are compared through the comparator to check if any significant discrepancy between the two waveforms, and the impedance functions of the PDR device and NDR device vary with temperature field, magnetic field flux intensity, optical field intensity, electrical field such as voltage, current, frequency or electrical power, mechanical field such as magnitude of force, vibration force or any combinations of them.

12. The assembly of claim 4, further comprising a plurality of switches, Lenz circuits, waveform decouplers, unidirection devices and a comparator, wherein at least a switch respectively parallels with the first switch or the second switch, and an unidirection device is respectively electrically connected in series with each switch, and a waveform decoupler is disposed neighboring between each unidirection device and each switch for decoupling waveform flowing between each unidirection device and each switch, and a waveform decoupler is disposed neighboring output waveform lines respectively of the first or second channels of the PWM controller for respectively decoupling the output waveforms respectively of the first or second channels of the PWM controller, and a Lenz circuit parallels with each switch and the unidirection device electrically connected in series, and each Lenz circuit comprises a PDR device, a NDR device and a capacitor or a diode electrically connected in series with each other, and all the switches in parallel with the first switch is driven by the output waveform of the first channel of the PWM controller or all the switches in parallel with the second switch is driven by the output waveform of the second channel of the PWM controller, and each waveform decoupled from each waveform decoupler associated with the first switch and the waveform decoupled from the waveform decoupler disposed neighboring output waveform line of the first channel of the PWM controller are compared through the comparator to find if any significant discrepancy between the two waveforms or each waveform decoupled from each waveform decoupler associated with the second switch and the waveform decoupled from the waveform decoupler disposed neighboring output waveform line of the second channel of the PWM controller are compared through the comparator to find if any significant discrepancy between the two waveforms, and the impedance functions of the PDR device and NDR device vary with temperature field, magnetic field flux intensity, optical field intensity, electrical field such as voltage, current, frequency or electrical power, mechanical field such as magnitude of force, vibration force or any combinations of them.

13. A backward current decoupler, comprising:
a first lamina having a plurality of paralleling fiber-type devices with a first end and a second end opposite to the first end; and
a second lamina having a plurality of paralleling fiber-type devices with a third end and a fourth end opposite to the third end;
wherein the plurality of the paralleing fiber-type devices at the first and second ends are respectively electrically connected together, and the plurality of the paralleing fiber-type devices at the third and fourth ends are respectively electrically connected together, and a forward current flows through two ends respectively of the first lamina and the second lamina then a backward current opposite to the forward current is induced by the input flowing through the other two ends respectively of the first lamina and second lamina, and the first lamina and the second lamina are crossed with each other through at least a device to form an array of junction devices, and each of the junction devices comprises:
a first fiber-type device;
a second fiber-type device; and
a third device;
wherein the first fiber-type device, the second fiber-type device and the third device are electrically connected in series with each other, and at least a portion of a surface of the first fiber-type device or the second fiber-type device is covered with the third device, and the first or second fiber-type device with the third device covering is fiber-type, and current flowing between the first fiber-type device and the second fiber-type device goes through the third device.

14. The backward current decoupler of claim 13, wherein the third device is a NDR device, and the impedance function of NDR device varies with temperature field, magnetic field flux intensity, optical field intensity, electrical field such as voltage, current, frequency or electrical power, mechanical field such as magnitude of force, vibration force or any combinations of them.

15. The backward current decoupler of claim 13, further comprising a fourth device, wherein the first fiber-type device, the second fiber-type device, the third device and the fourth device are electrically connected in series with each other, and the third device and fourth device comprise a PDR device and a NDR device, and the impedance functions of the PDR device and NDR device vary with temperature field, magnetic field flux intensity, optical field intensity, electrical field such as voltage, current, frequency or electrical power, mechanical field such as magnitude of force, vibration force or any combinations of them.

16. The backward current decoupler of claim 15, wherein at least a portion of a surface of the first fiber-type device is covered with the third device and at least a portion of a surface of the second fiber-type device is covered with the fourth device, and the first fiber-type device with the covering and the second fiber-type device with the covering are fiber-type.

17. The backward current decoupler of claim 15, wherein at least a portion of a surface of the first fiber-type device or the second fiber-type device is covered with the third device and at least a portion of a surface of the third device is covered with the fourth device, and the first fiber-type device with the covering or the second fiber-type device with the covering is fiber-type.

18. The backward current decoupler of claim 13, further comprising a fifth device, wherein the first fiber-type device, the second fiber-type device, the third device, the fourth device and the fifth device are electrically connected in series with each other, and the first fiber-type device and the second fiber-type device are crossed with each other through the third, fourth and fifth device, and current flowing between the first fiber-type device and the second fiber-type device goes through the third, fourth and fifth devices, and the third, fourth and fifth devices comprise a PDR device, a NDR device and a pure resistor, and the impedance functions of the PDR device and NDR device vary with temperature field, magnetic field flux intensity, optical field intensity, electrical field such as voltage, current, frequency or electrical power, mechanical field such as magnitude of force, vibration force or any combinations of them.

19. The backward decoupler of claim 18, wherein at least a portion of a surface of the first fiber-type device or the second fiber-type device is covered with the third device, and at least a portion of a surface of the third device is covered with the fourth device, and at least a portion of a surface of the fourth device is covered with the fifth device, and the first fiber-type device with the covering or the second fiber-type device with the covering is fiber-type.

20. The backward current decoupler of claim 18, wherein at least a portion of a surface of the first fiber-type device or the second fiber-type device is covered with the third device, and at least a portion of a surface of the third device is covered with the fourth device, and at least a portion of a surface of the uncovered first fiber-type device or second fiber-type device is covered with the fifth device, and the first fiber-type device with the covering and the second fiber-type device with the covering are fiber-type.

21. A damper, comprising:
a PDR device,
a NDR device, and
a pure resistor, wherein the PDR device, the NDR device and the pure resistor are electrically connected in series with each other, and the impedance functions of the PDR and NDR devices vary with temperature field, magnetic field flux intensity, optical field intensity, electrical field such as voltage, current, frequency or electrical power, mechanical force such as magnitude of force, vibration force or any combinations of them above.
